(19) United States
(12) Patent Application Publication
(10) Pub. No.: US 2013/0065765 A1
(43) Pub. Date: Mar. 14, 2013

(54) DEGRADABLE SUPERABSORBENT POLYMERS

(71) Applicants: Sergey Selifonov, Plymouth, MN (US); Marc Scholten, St. Paul, MN (US); Ning Zhou, Vadnais Heights, MN (US)

(72) Inventors: Sergey Selifonov, Plymouth, MN (US); Marc Scholten, St. Paul, MN (US); Ning Zhou, Vadnais Heights, MN (US)

(21) Appl. No.: 13/576,547

(22) PCT Filed: Jul. 5, 2011
(86) PCT No.: PCT/US11/42945

§ 371 Date: Oct. 1, 2012

(51) Int. Cl. A01N 25/12; C08G 4/00; C09D 161/00; B01J 20/26

(52) U.S. Cl. CPC C08G 4/00; C09D 161/00; B01J 20/262
USPC 504/361; 525/61; 524/557; 514/772.2; 502/402; 71/27; 507/124; 428/402; 428/403; 428/375; 442/59; 428/500

(57) ABSTRACT

The present disclosure relates to degradable superabsorbent materials based on acetals of glyoxylic acid and derivatives thereof with polyvinyl alcohol, and methods of making the polymers. The polymers are used to make superabsorbent particles, coatings, sheets, and fibers. Formulations and articles including the superabsorbent polymers, particles, coatings, sheets, and fibers are also disclosed.

This application is being filed as a PCT International Patent application on Jul. 5, 2011, in the name of Reluceo, Inc., a U.S. national corporation, applicant for the designation of all countries except the U.S., and Sergey Selifonov, a U.S. Citizen, Marc Scholten, a U.S. citizen, and Ning Zhou, a citizen of People's Republic of China, applicants for the designation of the U.S. only, and claims priority to U.S. Patent Application Ser. No. 61/361,448, filed Jul. 5, 2010, and U.S. Patent Application Ser. No. 61/370,215, filed Aug. 3, 2010; the contents of which are herein incorporated by reference in their entirety.

### BACKGROUND

Commercial superabsorbent polymers (SAP) are crosslinked networks of ionic polymers capable of absorbing large amounts of water and retaining the absorbed water under pressure. SAPs based on polymers and copolymers of acrylic acid were developed for commercial use in the late 1970s and have since replaced cellulosic or fiber-based products—tissue paper, cotton, sponge, and fluff pulp—in many absorbency applications. The water retention capacity of these fiber-based products is about 20 times their weight at most, more often about 12 times their weight. Additionally, the fiber-based absorbents notoriously release the absorbed water when pressure is applied to the swollen fibers. In contrast, acrylic-based SAP absorb more than 20 times their weight of deionized or distilled water. A comprehensive survey of superabsorbent polymers, and their use and manufacture, is given in F. L. Buchholz and A. T. Graham (editors) in “Modern Superabsorbent Polymer Technology,” Wiley-VCH, New York, 1998. The main industrial uses of commercial SAPs are as absorbents in personal disposable hygiene products, such as baby diapers, adult protective underwear and sanitary napkins. SAPs are also used for blocking water penetration in underground power or communications cable, as horticultural water retention agents, and for control of spill and waste aqueous fluid. Additional industrial uses of SAPs are known.

Currently, the most common SAP employed industrially is sodium polyacrylate (polyacrylic acid, sodium salt), typically crosslinked with a diacrylate or bisacrylamide, such as N,N′-methylene-bisacrylamide. Various copolymers of acrylamide and ethylene maleic anhydride are also employed as SAPs, as well as crosslinked carboxymethyl cellulose, starch, polyacrylate-polyvinyl alcohol copolymers, and polyethylene oxide. Similarly, the acrylic-type monomer itaconic acid is known be useful for making hydrogel-forming polymers. However, sections of polymeric polyelectrolyte chains including a preponderance of repeat units derived from polymerization of acrylic-type monomers (e.g. acrylic acid, acrylamide, itaconic acid and their salts) are not biodegradable and thus are persistent in the environment. Further, when acrylic copolymers and grafts are used in conjunction with degradable polymer materials, only the non-acrylic polymer segments have been conclusively demonstrated to undergo biodegradation.

Poly(vinyl alcohol) (PVOH) has been studied for superabsorbent use. PVOH itself is water soluble and well established as a biodegradable polymer. See, e.g. Chiellini, E. et al., Prog. Polym. Sci. 28, 963 (2003). Argade, B. et al., J. Appl. Pol. Sci. 70, 817 (1998) disclose poly(acrylic acid)-poly(vinyl alcohol) copolymers having superabsorbent properties. PVOH is partially dehydrated to form unsaturated sites, which are then polymerized in the presence of acrylic acid. Zhan, F. et al., J. Appl. Pol. Sci. 92(5), 3417 (2004) disclose a superabsorbent polymer formed by esterification of PVOH with phosphoric acid. The polymer was observed to release phosphate slowly upon exposure to moisture, and thus was employed as a slow-release fertilizer. However, phosphate release is associated with detrimental environmental effects; furthermore, a phosphate releasing composition is not suitable for use in many applications such as baby diapers, bandages, and the like.

When an aldehyde is reacted with PVOH, the product is a poly(vinyl acetal). Examples of poly(vinyl acetal)s include poly(vinyl formal), poly(vinyl butyral), and poly(vinyl glyoxylic acid). Poly(vinyl glyoxylic acid), or PVGA, is described in U.S. Pat. No. 2,187,570 and is a water- or alkali-soluble thermoplastic polyelectrolyte with emulsifying properties. Ise, N. and Okubo, T. J. P. Chem. 70(6), 1930-1935 (1966) disclose solutions of PVOH partially acetalized with glyoxylic acid. U.S. Pat. Nos. 4,306,031 and 4,350,773 disclose crosslinked PVGA as weakly acidic cation exchange resins having a swelling volume in water of 10 ml/g or less. And Sakurada, I. and Ikada, Y., Bull. Inst. Chem. Res., Kyoto Univ, 40(1-2), 25-35 (1962) describe dilute solutions of PVGA polymers crosslinked by ionizing radiation in the presence of water and sodium chloride solutions.

### SUMMARY OF THE INVENTION

Disclosed herein are degradable polymers, useful for forming superabsorbent polymer particles, coatings, sheets, and fibers, collectively referred to herein as “SAP”. The SAP are based on poly(vinyl glyoxylic acid), the neutralized carboxylate derivatives thereof, copolymers thereof, functionalized derivatives thereof, and crosslinked matrixes thereof, referred to collectively herein as poly(vinyl glyoxylic acid), or “PVGA”. The PVGA is crosslinked in an amount sufficient to enable the PVGA to form a hydrogel when contacted with aqueous liquids. Crosslinking is accomplished using any one of a variety of crosslinking reactions or combination of two or more such reactions. The carboxylic groups present in crosslinked PVGA polymers are at least partially neutralized to the corresponding carboxylate salts, employing any of a variety of organic or inorganic species. Reactions usefully employed to form PVGA are easily carried out employing inexpensive, known materials and straightforward, industrially scalable and efficient processing conditions. Careful selection of a polyvinyl alcohol starting material, type and amount of glyoxylate derivative, and careful control of crosslinking are combined to result in a network polymer that, when dry, is a SAP having superior absorption capacity and absorption rate of aqueous liquids. These properties make the PVGA SAP of the invention suitable for highly demanding applications such as baby diapers. We have found the SAP of the invention to be at par with commercial acrylic-based diaper SAP, including in the ease of synthesis, but with the added advantages of environmental degradability and derivability from renewable carbon sources such as acetic acid or ethanol-based ethylene.

PVGA is processed to produce SAP in the form of particles, coatings, sheets, and fibers using the methods disclosed herein. In their dry form, some SAP of the invention have a unique and advantageous surface morphology described herein as a convoluted surface morphology. For the purposes of this disclosure, “convoluted” means folded in curved or tortuous windings; furrowed, wrinkled, fissured, or grooved. This surface morphology increases the specific surface area of the SAP articles in a manner that translates to the rapid rate of uptake of aqueous liquids by the dry SAP articles. In some embodiments, SAP particles have the convoluted surface morphology over at least a portion of the surface thereof. In other embodiments, SAP coatings have the convoluted surface morphology over at least a portion of the surface thereof. The SAP coatings are formed on a solid or semi-solid surface; on fibers, particles, or porous or nonporous substrates; on any type of surface from flat to irregular; and in continuous or discontinuous coated fashion. In still other embodiments, freestanding SAP sheets or fibers are formed having the convoluted surface morphology over at least a portion of the surface thereof.

The PVGA networks that are the basis of the SAP articles absorb many times their own weight of aqueous liquids without dissolving. “Aqueous liquids” include water, saline solutions, aqueous solutions of drugs, and complex mixtures such as urine, synthetic urine, blood, and the like; aqueous waste effluents, groundwater and sewage, and the like. The chemical nature of the PVGA networks is correlated to the absorption capacity and rate of absorption of a particular aqueous liquid, while available surface area further contributes to the rate of absorption of a particular aqueous liquid by the SAP of the invention. The absorption capacity and rate of absorption of the various SAP of the invention are sufficient to render them suitable for challenging applications such as disposable diaper applications. In some embodiments, the absorption capacity combined with the superior rate of absorption of aqueous liquids achieved by the SAP of the invention is equal to or better than acrylic-based commercial superabsorbent materials employed in disposable diaper applications.

The SAP of the invention in the presence of absorbed aqueous liquids are called hydrogels, SAP hydrogels, or PVGA hydrogels, where a “hydrogel” is a composition composed of an aqueous liquid entrapped in a crosslinked polymer network. The hydrogels of the invention are similar in appearance and behavior to those formed using conventional SAP. Hydrogels formed from SAP particles are many times the size of the dry SAP particles but the hydrogel does not dissolve. In embodiments, the hydrogels have a high modulus, that is, a low tendency to deform elastically when force is applied to the hydrogel. This in turn results in a high retention of absorbed aqueous liquids under load. Additionally, the swollen hydrogels are degelled by exposing the hydrogel to mild conditions. For example, in some embodiments, contacting a hydrogel with a weak organic acid results in the apparent reduction of gel content. After exposure, a major fraction of the hydrogel becomes fully dispersible or soluble in water over a period of days. Other agents are likewise useful in “degelling” the hydrogels. In some embodiments, the water dispersible or soluble fraction of the degelled PVGA hydrogel is principally composed of glyoxylic acid or a carboxylate derivative thereof, and a polyvinyl alcohol or a partially de-acetalized polyvinyl alcohol. In some such embodiments, the degelled PVGA hydrogels consist principally of biodegradable and environmentally harmless components. In embodiments, a degelling agent is encapsulated and mixed with, or incorporated in or near the dry SAP such that release of the degelling agent is brought about by contact with the aqueous liquid that swells the SAP to form the hydrogel.

The SAP of the invention are easily synthesized and processed using commercially available materials. Additionally, all materials useful in making the SAP of the invention are derivable from renewable carbon sources such as acetic acid or ethanol-based ethylene. Absorption capacity and absorption rate of aqueous liquids by the SAP of the invention are commensurate with commercial acrylic-based SAP compositions. Unique surface morphology imparted to the dry SAP of the invention gives rise to increased rates of absorption of aqueous liquids. The SAP of the invention are degelled under mild conditions to form environmentally degradable or environmentally harmless products.

Additional advantages and novel features of the invention will be set forth in part in the description that follows, and in part will become apparent upon examination of the following, or may be learned through routine experimentation upon practice of the invention.

### BRIEF DESCRIPTION OF THE DRAWINGS

FIG. 1 is a scanning electron micrograph of a first SAP particle at 100×.

FIG. 2 is a scanning electron micrograph of the first SAP particle at 1000×.

FIG. 3 is a scanning electron micrograph of a second SAP particle at 100×.

FIG. 4 is a scanning electron micrograph of the second SAP particle at 1000×.

FIG. 5 is a scanning electron micrograph of the second SAP particle at 75,000×.

FIG. 6A, 6B, 6C show appearance over time of a PVGA in the presence of water.

FIG. 7 is a plot of microbial growth in a medium having glyoxylic acid as sole carbon source.

FIG. 8 is a ¹H NMR spectrum of a polymer of the invention and a starting material.

FIG. 9 is a plot of grams of aqueous liquid absorbed as a function of time for polymers of the invention and a control material.

FIG. 10 is a plot of wt % gel as a function of time for some polymers of the invention.

FIG. 11A, 11B are comparative ¹H NMR spectra of a compound and a reaction product of a polymer of the invention.

### DETAILED DESCRIPTION

The superabsorbent polymer (SAP) materials of the invention are based on the cyclic acetal reaction products of glyoxylic acid or a salt or ester thereof with two contiguous polyvinyl alcohol repeat units. The crosslinked products of such reactions are referred to herein generally as “poly(vinyl glyoxylic acid)” or “PVGA.” In various embodiments of the invention, a polyvinyl alcohol, referred to herein as “PVOH”, is reacted with glyoxylic acid, a glyoxylate ester, or a glyoxylate salt, collectively referred to herein generally as “glyoxylate derivatives,” to form an acetal functionalized polymer. The polymer is crosslinked by one of a variety of reactions, or a combination of two or more reactions. The final crosslinked polymer product is a superabsorbent, or SAP. A representative reaction scheme is shown in Scheme I below:

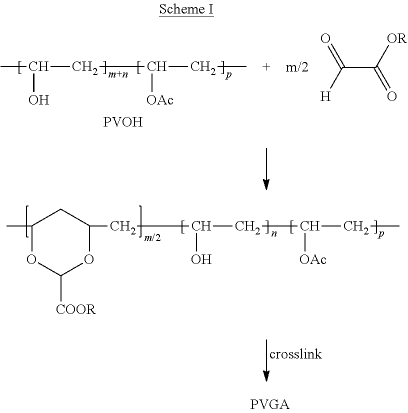

wherein R is hydrogen; a linear, or branched, or cyclic alkyl group having between 1 and 6 carbon atoms; or a cation, for example a Group I metal of the Periodic Table such as sodium, potassium, or lithium; or a quaternary amine, tertiary amine, or ammonium cation. In many embodiments, a combination of glyoxylic acid (R=H) and a glyoxylate salt (R=cation) is employed in the reaction to form the PVGA of the invention. The crosslinking step takes place, in various embodiments, before, after, or contemporaneously with the reaction of PVOH with the glyoxylate derivative. It will be understood that the polymer compositions of the invention, the formulations of the invention, and the articles of the invention are advantageously combined with any one or more of the more specific embodiments described below, and that the various embodiments are specifically intended to be combined in any combination without limitation.

### Polyvinyl Alcohol (PVOH)

Some PVOH materials are described in this section; the PVOH materials are intended to be used in combination with any of the syntheses and processes to form the SAP of the invention, and result in a range of physical properties as described in any of the embodiments of SAP as described in this section and other sections. Furthermore, the SAP formed by such combinations are useful in any one or more formulations and articles of the invention as described herein.

“Polyvinyl alcohol” and “PVOH” as used herein means a polymer having at least 50 mole %, and up to 100 mole %, repeat units attributable to vinyl alcohol. Reference to specific types of PVOH does not exclude other types unless such other types are expressly excluded. Commercially, PVOH is produced by alcoholysis, most typically methanolysis, of a poly(vinyl alkanoate), for example poly(vinyl acetate) (PVA), since vinyl alcohol monomer does not exist in the free state. Alcoholysis of PVA to form PVOH is often referred to in the art as hydrolysis. Thus, industrially manufactured PVOH is thus a partially or completely alcoholyzed homopolymer or copolymer of vinyl acetate having any molecular weight, any degree of alcoholysis, and with any endgroups; wherein alcoholyzed content within the polymer is randomly dispersed, present as blocks, or present as grafted moieties. PVOH may be linear, branched, or crosslinked. In embodiments, PVOH is usefully employed as the starting material for reactions to form PVGA. In such embodiments, the molecular weight of PVOH is between about 10,000 g/mol and 3,000,000 g/mol. In some embodiments, the molecular weight of PVOH is between about 25,000 g/mol and 2,000,000 g/mol. In some embodiments, the molecular weight of PVOH is between about 50,000 g/mol and 1,000,000 g/mol. In some embodiments, the molecular weight of PVOH is between about 100,000 g/mol and 250,000 g/mol. In some embodiments, the molecular weight of PVOH is between about 10,000 g/mol and 250,000 g/mol. In some embodiments, the molecular weight of PVOH is between about 50,000 g/mol and 250,000 g/mol. In some embodiments, about 50 mole % to 100 mole % of the PVOH repeat units are attributable to vinyl alcohol. In some embodiments, about 80 mole % to 100 mole % of the PVOH repeat units are attributable to vinyl alcohol. In some embodiments, about 95 mole % to 99 mole % of the PVOH repeat units are attributable to vinyl alcohol. In embodiments, the PVOH is substantially linear; in other embodiments, the PVOH is branched. It is understood that due to the nature of the polymerization of vinyl acetate, the alcoholyzed product PVOH materials arising therefrom are composed of repeat units bearing hydroxyl groups primarily situated in 1,3-arrangement, wherein every other carbon of the PVOH backbone has a hydroxyl substituent. However, in embodiments PVOH also contains varying but typically minor molar amounts of 1,2-dihydroxyl moieties arising from the “head-to-head” addition of vinyl acetate monomers. In some embodiments, PVOH is a copolymer having one or more additional monomers not attributable to vinyl acetate or vinyl alcohol. In such embodiments, the comonomers are preferably not acrylate; however, PVOH copolymers are not particularly limited within the scope of the invention. Where the starting polymer is PVOH or polyvinyl acetate (PVA), and has repeat units attributable only to vinyl acetate and the alcoholysis product thereof, the endgroups are typically either hydrogen or the reaction product of a radical initiator depending on the nature of the polymerization reaction.

In some embodiments, PVA is usefully employed as the starting material for reaction to form PVGA, without the intermediate step of hydrolysis of PVA to form PVOH. In such embodiments, the same degree of polymerization and polymer structure (linear, branched etc.) is employed as with PVOH. In other embodiments, PVA or PVOH is a copolymer with ethylene, commonly referred to as EVA or EVOH, respectively. In some such embodiments, the ratio of ethylene to vinyl acetate or vinyl alcohol repeat units is about 0.1:99.9 to 5:95. Other copolymers are also useful in forming the SAPs of the invention. For example, as mentioned above, vinyl alkanoates other than vinyl acetate are useful as monomers from which alcoholyzed polymers are synthesized and thus PVOH is, in some embodiments, a copolymer of vinyl alcohol and the residual vinyl alkoanate moieties. Additionally, in embodiments, any of the vinyl alkanoates are copolymerizable with various olefinic or vinylic monomers including, for example, maleic anhydride, acrylic or methacrylic monomers, itaconic acid, and diketene. In some such embodiments, the ratio of olefinic or vinylic repeat units to vinyl alkanoate or vinyl alcohol repeat units is about 0.1:99.9 to 20:80.

Suitable PVOH polymers are obtained, for example, from Celanese Corporation of Dallas, Tex. under the trade name CELVOL®; from Denki Kagaku Kogyo Kabushiki Kaisha (Denka Corp.) of Tokyo, Japan, under the trade name POVAL®; from Kuraray America, Inc. of Houston, Tex. under trade names K-POLYMER®, MOWIOL®, MOWIFLEX®, MOWITAL®, or POVAL®; from Chris Craft Industrial Products, Inc., MonoSol Division of Gary, Ind. under the trade name MONO-SOLO; or from the DuPont deNemours Co. of Wilmington, Del. under the trade name ELVANOL®, for example ELVANOL® 70-62. In some embodiments, PVOH is obtained as a dispersion in water. For example, dispersions of about 5 wt % to 20 wt % PVOH are obtained from some commercial sources.

PVOH can be obtained from 100% non-fossil carbon sources. The PVA that is alcoholyzed to form PVOH is traditionally a fossil carbon-based product, because vinyl acetate is conventionally synthesized from acetylene or ethylene and acetic acid. However, methods have been developed in which acetic acid is the sole feedstock in the synthesis of vinyl acetate, proceeding via a ketene intermediate. Such a route allows for utilization of renewable acetic acid as a feedstock when latter compound is prepared by fermentation or by biomass hydrolysis. Acetic acid is synthesized industrially either by bacterial fermentation of ethanolic feedstocks or by carbonylation of methanol with carbon monoxide; methanol is in turn synthesized industrially from methane sourced from natural gas. Additionally, methods are known to prepare acetylene from renewable feedstocks such as biomass-derived charcoal by reaction with lime, followed by aqueous decomposition of resulting calcium carbide compound. Finally, methods are known by which ethylene is derived from ethanol, ethanol being a renewably derived resource.

In some embodiments, a PVOH starting material is subjected to a limited oxidation of secondary hydroxyls to allow for incorporation of carbonyl (ketone) groups or oxocarbonyl groups. Suitable methods of oxidation are disclosed in U.S. Pat. No. 5,219,930 and in the references cited therein; PVOH oxidation is also catalyzed by certain metalloenzymes such as peroxidases and laccases. The reaction products of such oxidation are, in embodiments, photodegradable and biodegradable as taught in the references.

### Glyoxylate Derivatives

Some glyoxylate derivatives are described in this section; the glyoxylate derivatives are intended to be used in combination with any of the syntheses and processes of the SAP materials of the invention, and result in a range of physical properties as described in any of the embodiments of SAP as described in this section and other sections. Furthermore, the SAP formed by such combinations are useful in any one or more formulations and articles of the invention as described herein.

Glyoxylic acid, OHC—COOH, is also known as oxaldehydic acid (IUPAC), formylformic acid, and oxoacetic acid. Glyoxylic acid, glyoxylate esters, and glyoxylate salts are commercially available compounds. Glyoxylic acid and glyoxylate salts are naturally occurring. Glyoxylic acid is an intermediate of the glyoxylate cycle, a metabolic pathway that enables organisms, such as bacteria, fungi, and plants to convert isocitrate to glyoxylate and succinate within Tricarboxylic Acid Cycle known as the TCA or Krebs cycle. In water solutions, glyoxylic acid exists in equilibrium with its reaction product with water, which has the molecular formula (HO)₂CHCO₂H, often described as the “monohydrate.” This diol further exists in equilibrium with the dimeric hemiacetal in solution:

2(HO)₂CHCO₂H [symbol] O[(HO)CHCO₂H]₂+H₂O

however, in terms of reactivity, glyoxylic acid in water retains its aldehyde character.

Industrially, glyoxylic acid is manufactured in a cost-effective fashion from ethylene glycol via glyoxal, using methods known in the art. Ethylene glycol is industrially made from an ethylene feedstock derived either from fossil carbon compounds or from ethanol produced by fermentation of renewable feedstocks. Alternatively, ethylene glycol can be prepared in industrially useful quantities by hydrogenolysis of renewable glycerol or sorbitol. Glyoxylic acid of high purity can also be industrially manufactured by ozonolysis of maleic anhydride (MA). MA is produced industrially by oxidation of n-butane or 2-butene, with the latter compound readily prepared by dehydration of 1-butanol, a compound known in the art to be industrially accessible from renewable carbon sources.

In various embodiments of the invention, PVOH is reacted with glyoxylic acid, a glyoxylate ester, or a glyoxylate salt, collectively referred to herein generally as “glyoxylate derivatives,” to form the corresponding acetal groups. Referring to Scheme I above, in many embodiments, a combination of glyoxylic acid (R=H) and a glyoxylate salt (R=cation) is employed in the reaction to form the PVGA of the invention. In embodiments, 0 mol % to about 50 mol % of glyoxylate salt is employed in a reaction to form a PVGA polymer of the invention, with the balance being glyoxylic acid. In still other embodiments, R of a glyoxylate derivative is a divalent, trivalent, or higher valency cation; thus, for example, calcium, magnesium, borate, or aluminate salts of one or more glyoxylate carboxyl groups are useful in some embodiments of the invention. In still other embodiments, R of a glyoxylate derivative is ammonium or a quaternary salt such as tetramethylammonium, pyridinium, imidazolium, triazolium, or guanidinium; and in still other embodiments R of a glyoxylate derivative is a phosphonium salt. In still other embodiments, multifunctional variations of ammonium and phosphonium salts are useful counterions for two or more glyoxylate moieties. For example, the polyethyleneimine and polyphosphonium salts are useful as multifunctional counterions for glyoxylate groups in the PVGA.

Reactions of PVOH with Glyoxylate Derivatives

Some embodiments of PVGA synthetic schemes are described in this section; the synthetic schemes are intended to be used in combination with any of the syntheses and processes the PVGA materials of the invention, and result in a range of physical properties as described in any of the embodiments of PVGA materials as described in this section and other sections. Furthermore, the PVGA materials synthesized by such combinations are useful in any one or more formulations and articles of the invention as described herein.

Referring again to Scheme I, “PVGA” generally refers to any reaction product of PVOH with a glyoxylate derivative or mixture of two or more glyoxylate derivatives. In some embodiments wherein R of PVGA is a cation, the PVGA is referred to as a “neutralized PVGA.” In some embodiments, PVGA is partially neutralized, that is, there are glyoxylic acid and/or glyoxylate ester moieties present in addition to glyoxylate salt moieties; such embodiments are said to be “partially neutralized PVGA.” Partially neutralized PVGA arises, for example, by reacting partially neutralized glyoxylic acid with PVOH, or by reacting glyoxylic acid, a glyoxylate ester, or both with PVOH followed by partial neutralization. In some embodiments, partially neutralized PVGA is further neutralized by contact with a base to form neutralized PVGA.

Table 1 shows the theoretical amount, expressed as dry weight, of glyoxylic acid that is reacted with PVOH and the corresponding percent acetalization at various levels of acetalization according to the scheme shown in Scheme I. The weight-weight ratios expressed in Table 1 assume 100% alcoholysis, that is, p=0 in Scheme I. The translation of that weight-weight ratio to percent acetalization assumes that all glyoxylate derivatives react and no carboxyl groups of the glyoxylic acid or glyoxylate derivative react with hydroxyl groups of the PVOH. One of skill will understand that the theoretical amount of 100% acetalization is not achievable in practicality, because there will inevitably be some amount of residual single hydroxyl groups remaining on the polymer backbone, wherein each neighboring hydroxyl is acetalized. In some embodiments, the PVGA of the invention incorporate about 30% to 90% acetalization. In other embodiments, the PVGA of the invention incorporate about 50% to 80% acetalization. In still other embodiments, the PVGA of the invention incorporate about 60% to 75% acetalization.

TABLE 1
Weight ratio of glyoxylic acid to PVOH polymer and
corresponding % acetalization at various levels.

| | Wt. glyoxylic acid/wt. PVOH | | | | | | |
|---|---|---|---|---|---|---|---|
| | 0.84 | 0.675 | 0.63 | 0.59 | 0.505 | 0.42 | 0.385 |
| % acetalization | 100 | 80 | 75 | 70 | 60 | 50 | 40 |

In various embodiments, PVGA of the invention are formed according to Scheme I using any one of a number of industrially useful techniques. Such techniques are carried out, in various embodiments, as batchwise reactions; or in semi-continuous reactions; or as continuous reactions as will be appreciated by one of skill. In one embodiment, a solution of about 40 wt % to 60 wt % of glyoxylic acid or a solution of about 50 wt % to 80 wt % of a glyoxylate salt in water is mixed with a waterborne dispersion of about 5 wt % to 25 wt % of PVOH. In other embodiments, the waterborne solution of glyoxylic acid, or a mixture of glyoxylic acid and glyoxylate salt, is used to disperse dry PVOH. In still other embodiments, neat glyoxylate derivative is added to a waterborne dispersion of about 5 wt % to 25 wt % PVOH. In some embodiments, particularly where the glyoxylate derivative is glyoxylic acid, pH is adjusted after mixing glyoxylic acid and PVOH by adding NaOH, KOH, or an alkali metal carbonate, bicarbonate, sesquicarbonate, or a mixture thereof, preferably in the form of a 1M to 15M aqueous solution. In such embodiments, the pH of the homogeneous mixture is adjusted to between about −1 and 7, or between about 1 and 5, or between about 1 and 3, or even between about 1 and 2. In still other embodiments, pH of the mixture is not adjusted prior to isolation of the PVGA. In still other embodiments, glyoxylic acid is neutralized or partially neutralized to a glyoxylate salt prior to reacting with PVOH. In some such embodiments, NaOH, KOH, or an alkali metal carbonate, bicarbonate, sesquicarbonate, or a mixture thereof is preferably in the form of a 1M to 15M aqueous solution; the selected amount of solution is mixed with glyoxylic acid to neutralize all or a portion of the glyoxylic acid prior to mixing with PVOH. In some such embodiments, the molar ratio of glyoxylic acid to glyoxylate salt used in the reaction with PVOH is about 99.9:0.1 to 50:50, or about 90:10 to 60:40, or about 80:20 to 60:40, or about 75:25 to 65:35, or about 70:30. In some embodiments where the glyoxylate derivative is a mixture of glyoxylic acid and a glyoxylate salt, the glyoxylate salt is sodium glyoxylate or potassium glyoxylate. In some embodiments where the glyoxylate derivative is a mixture of glyoxylic acid and a glyoxylate salt, the remaining acid groups are neutralized after reaction with PVOH. In other embodiments, no further neutralization is carried out. In conjunction with any of the above mixing schemes, additional functional compounds, described in detail below, are optionally added to the PVOH at the same time as glyoxylate derivative, before adding the glyoxylate derivative, or after adding the glyoxylate derivative depending on optimal conditions of reactivity and yield of the desired PVGA product.

In some embodiments, a PVGA is formed by simply admixing a PVOH dispersed in water with a glyoxylate derivative, along with any desired additional functional compounds, and evaporating at least a portion of the water. In some such embodiments, the PVOH dispersion is heated prior to admixing to more thoroughly disperse or dissolve the polymer. In some embodiments, the reaction mixture is heated. In some embodiments, a PVGA hydrogel results that is isolated and partitioned, such as by a pelletizing extruder, grinder etc. Then water is removed from the homogeneous reaction mixture employing heat and/or vacuum. In other embodiments, PVGA is formed by admixing PVOH and one or more glyoxylate derivatives, along with any desired additional functional compounds, in a water dispersion and the mixture is divided into droplets prior to gelation; the reaction to form the PVGA is completed in individual droplet form and dried to yield dry particles.

It will be understood that because the reaction of PVOH and one or more glyoxylate derivatives is a condensation reaction, the reaction is driven to completion by the evaporation of water. Thus, while heating of the reaction is not necessary, evaporation of water is a required step in order to realize sufficient yield of acetalization by the glyoxylate derivative to form a SAP. Evaporation of water is carried out using known procedures such as employing heat, lowering pressure, or a combination thereof to facilitate the acetal formation. As used herein, “evaporation of water” means evaporation of some portion of the water associated with the reaction to form the PVGA. It is not necessary to remove all of the water; in embodiments, concentrating the reaction mixture by removing 5 wt % to 10 wt % of the water is sufficient to drive the reaction to substantial completion. In other embodiments, evaporation of as much as 90 wt %, even 95 wt %, or as much as 99 wt % of the water or more is required to drive the reaction to completion. In some embodiments, evaporation is the same as drying, wherein drying is described in detail below. In other embodiments, evaporation is a separate step from drying.

In some embodiments, the reaction to form PVGA occurs without adding an acid catalyst because the acidity of glyoxylic acid is sufficient to catalyze the reaction between glyoxylic derivative and PVOH. In such embodiments the reaction mixture is simply stirred for an hour or more to obtain a PVGA acid or a PVGA having a mixture of acid and salt moieties. In other embodiments, a small amount of a protic acid such as acetic acid, nitric acid, sulfuric acid, sulfamic acid, or hydrochloric acid, is further employed as a catalyst. For example, in some embodiments, about 1×10⁻⁸ moles to 1×10⁻² moles of an acid catalyst is employed as a catalyst for each mole of glyoxylate derivative employed in the reaction to form the PVGA. In embodiments where the reaction is run in water, the temperature of the reaction is between about 0° C. and 100° C. In some such embodiments, the temperature of the reaction is between about 22° C. and 100° C.; in other embodiments the temperature of the reaction is between about 50° C. and 99° C.; in other embodiments the temperature of the reaction is between about 60° C. and 90° C.; in other embodiments the temperature of the reaction is between about 18° C. and 22° C.; in still other embodiments the temperature of the reaction is between about 18° C. and 0° C. In some embodiments, the reaction is carried out by dispensing the reaction mixture onto a heated substrate such as a drum or belt. In such embodiments, the heated substrate temperature is between 30° C. and 180° C., for example between 90° C. and 160° C. In some embodiments, the reaction is carried out under reduced pressure, that is, at less than 1 atm; in embodiments the pressure employed is as low as about 0.5 atm; in other embodiments the pressure is as low as about 0.1 atm. In some embodiments, the reaction is carried out under pressure, that is, at greater than 1 atm; in embodiments the pressure employed is as high as about 10 atm; in other embodiments the pressure employed is as high as about 50 atm.

In some embodiments, the reaction of PVOH with one or more glyoxylate derivatives in water is carried out using a total molar ratio of glyoxylate derivative reflecting the targeted degree of PVOH functionalization. In other embodiments, the reaction of PVOH with one or more glyoxylate derivatives in water is carried out using a molar excess of glyoxylate derivative. Referring to Scheme I, a molar amount exceeding m/2, or even exceeding (m+n)/2) of glyoxylate derivative is employed in some such embodiments. In some such embodiments, the unreacted glyoxylate derivative is removed after the reaction is complete, for example by membrane separation, column separation, distillation, solvent partitioning, precipitation of the PVGA, washing of a PVGA hydrogel, and the like. In some embodiments, excess glyoxylate derivative is removed by washing the PVGA hydrogel in water or an aqueous solvent mixture. Such aqueous solvent mixtures are described in detail below.

An advantage of employing glyoxylate salt instead of glyoxylic acid in the reaction with PVOH is that the carboxylate salt has lower reactivity than the free acid to esterification reactions with free residual hydroxyl groups of the PVOH or PVGA, which, in some embodiments, forms a crosslink between the hydroxyl and the acetalized glyoxylate derivative. Selectivity for acetalization over esterification is important to the overall success of the invention, because uncontrolled crosslinking by esterification or transesterification of glyoxal derivatives will, in some embodiments, reduce the water absorptivity of the final PVGA. Additionally, employing an optimized mixture of glyoxylate salt and glyoxylic acid in the reaction with PVOH provides a balance of acid catalyzation of the reaction with selectivity for acetalization over esterification.

Where glyoxylic acid or a mixture of glyoxylic acid and a glyoxylate salt is employed in the reaction, the resulting PVGA is subsequently neutralized by reaction with ammonia, lithium hydroxide, sodium hydroxide, potassium hydroxide, or another base to form the corresponding PVGA salt. Similarly, where a glyoxylate ester is employed in the reaction, the resulting PVGA is saponified by reaction with ammonia, lithium hydroxide, sodium hydroxide, potassium hydroxide, or another saponifying agent to form the corresponding PVGA salt. In some embodiments the neutralization is carried out prior to drying the PVGA; in other embodiments, neutralization is carried out after drying the PVGA, by addition of a solution of the base in water. Where a the reaction to form PVGA is carried out in water, neutralization or saponification is carried out by simply adding ammonia, for example by bubbling ammonia gas through the reaction pot, or by adding the desired molar equivalent of a Group I metal hydroxide with the reaction mixture in water, optionally with the addition of heat. Where neutralization is carried out after isolation and drying of PVGA, the dry PVGA is simply soaked with the amount of neutralizing agent—typically in the form of a 0.1M to 15M solution of a Group I metal hydroxide—selected to neutralize some or all of the ester or free acid moieties present in the dry PVGA.

An additional advantage of neutralizing the PVGA after the reaction of glyoxylic acid or a mixture of glyoxylic acid and glyoxylate salt with PVOH is that the base serves to break up a an amount of crosslinking due to esterification of glyoxylic acid with residual hydroxyls of the PVOH. This type of crosslink is depicted for two individual repeat units in Scheme II.

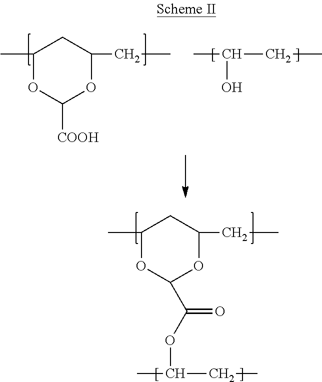

As will be described in further detail below, some such crosslinking is desirable because PVGA must be crosslinked in order to form a hydrogel; otherwise it will simply disperse when contacted with aqueous liquids. However, an excessive amount of crosslinking restricts the ability of the hydrogel to swell, which in turn translates to a reduction in the absorptive capacity of a SAP formed from the PVGA. Therefore, the amount of base employed to neutralize the PVGA is an amount sufficient to convert essentially all of the carboxylic acid groups to carboxylate salt, plus saponify some portion of the ester crosslinks of the type shown in Scheme II. In some embodiments, the molar amount of theoretical free carboxylic acid groups is calculated based on the amount of glyoxylic acid employed in the reaction, and an amount of a simple alkali base such as sodium hydroxide is added based on about 100.1% to 115% of the molar equivalent of theoretical free carboxylic acid groups, or about 101% to 110% of the molar equivalent of theoretical free carboxylic acid groups, or about 102% to 107% of the molar equivalent of theoretical free carboxylic acid groups, or about 105% of the molar equivalent of theoretical free carboxylic acid groups.

### Crosslinking of PVGA

Some additional embodiments of PVGA synthetic schemes are described in this section; the additional synthetic schemes are intended to be used in combination with any of the syntheses and processes the PVGA materials of the invention, and result in a range of physical properties as described in any of the embodiments of SAP as described in this section and other sections. Furthermore, the PVGA materials synthesized by such combinations are useful in any one or more formulations and articles of the invention as described herein.

It is a necessary aspect of the invention to crosslink the PVGA of the invention. The superabsorptivity is imparted by forming a crosslinked network of PVGA because with no crosslinking the PVGA will, in many embodiments, disperse rather than form a hydrogel in the presence of an aqueous liquid. Thus, in embodiments where the PVGA of the invention are referred to as SAP, the PVGA are crosslinked in a selected amount. The amount is selected based on the intended application of the SAP, and the selected amount of crosslinking is incurred by careful control of reaction conditions as well as by optional addition of crosslinking agents as will be described.

In some embodiments, crosslinking is carried out during the reaction of a glyoxylate derivative with PVOH or PVA without employing additional compounds or catalysts. For example, the reaction of the glyoxylate carboxyl group with a residual hydroxyl moiety from PVOH to form an ester crosslink is described above; such reactions occur during PVGA synthesis where glyoxylic acid or a glyoxylate ester are present but are reversible to a selected degree when the resulting PVGA is treated with a base. In some embodiments, the presence of acid, particularly a strong protic acid, in conjunction with application of heat during the synthesis of PVGA causes condensation of PVOH hydroxyls with other PVOH hydroxyls to form ether linkages. For example, in some embodiments where glyoxylic acid is obtained from industrial sources, it is supplied with trace amounts of strong acids such as nitric acid. Additionally, without being limited by theory, we believe that in many embodiments, an amount of crosslinking of PVGA takes place by formation of small quantities of acyclic acetals of glyoxylate derivatives, wherein two hydroxyl groups of different PVOH polymer chains participate in the formation of an acyclic glyoxylic acetal.

In embodiments where PVGA is crosslinked by employing a compound other than the glyoxylate derivative and/or PVOH, the compound employed to carry out the crosslinking reaction is referred to as a “crosslinking agent” or “crosslinking compound.” In some embodiments, a crosslinking agent is employed that reacts with only one hydroxyl moiety of the PVOH or PVGA per crosslink locus, for example where the crosslinking agent is a diacid or diester. In some embodiments, reactions with a diester or diacid crosslinking agent is advantageously employed after the maximum number of acetal functionality has been formed and makes use of residual isolated hydroxyl groups from PVOH. Non-limiting examples of suitable diacids include aliphatic, cycloaliphatic or aromatic dicarboxylic acids, for example, succinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid, maleic acid, fumaric acid, naphthalene dioc acid, dimerized fatty acids, or hydrogenated dimerized fatty acids. Similarly useful for crosslinking residual isolated hydroxyl groups from PVOH are acid anhydrides such as o-phthalic, maleic or succinic anhydrides. Such reactions are described in numerous references wherein esterification or transesterification reactions are discussed. Similarly useful for crosslinking residual isolated hydroxyl groups from PVOH are diepoxide compounds such as 1,2-3,4-diepoxy butane; glycidylethers such as bis-epoxypropylether, ethyleneglycol bis-epoxypropylether and 1,4-butanediol bisepoxypropylether, or epihalohydrins such as epichlorohydrin and epibromohydrin. Such reactions are described, for example, in U.S. Pat. No. 4,350,773. Similarly useful for crosslinking residual isolated hydroxyl groups from PVOH are carbonate esters, such as diethyl carbonate or a cyclic carbonate ester.

In other embodiments, a dialdehyde is employed as the crosslinking agent. In some such embodiments the dialdehyde is included in the reaction mixture of PVOH and glyoxylate derivative such that acetal crosslinks are formed contemporaneously with the reaction of glyoxylate derivative with PVOH. One such crosslinking scheme is shown in Scheme III.

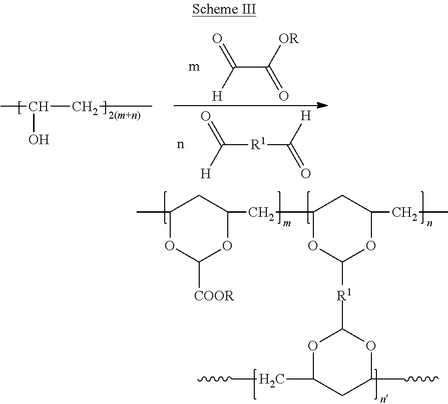

Referring to Scheme III, n moles of a dialdehyde having a variable R¹ moiety between aldehyde groups is added to PVOH along with m moles of a glyoxylate derivative, where R is the same as for Scheme I. R¹ is not particularly limited within the scope of the reaction and in various embodiments is a covalent bond or a linear, branched, or cyclic alkyl or alkenyl group or an aryl or alkaryl group, optionally containing one or more heteroatoms. Non-limiting examples of suitable dialdehydes useful in one or more crosslinking reactions of the present invention include, for example, ethanedial (glyoxal), glutaraldehyde (pentanedial), malonaldehyde (propanedial), butanedial, adipaldehyde (hexanedial), fumaraldehyde, oct-4-enedial, formylvanillin (4-hydroxy-5-methoxybenzene-1,3-dicarbaldehyde), pyridine-2,6-dicarbaldehyde, piperazine-1,4-dicarbaldehyde, furan-2,5-dicarbaldehyde, o-phthaldehyde, and terephthalaldehyde. In some embodiments, the dialdehyde crosslinking agent is added with the glyoxylate derivative to PVOH, such that PVGA formation and crosslinking takes place in a single step. In embodiments where the reaction takes place in water, it is preferable to use a water soluble dialdehyde such as glyoxal.

In an alternate embodiment, an aldehyde or carboxylic acid bearing a UV reactive group is employed in the PVGA synthesis, and at the desired time PVGA is irradiated with UV light of a suitable wavelength and power for a suitable amount of time such that the UV reactive groups react to form crosslinks. “UV light” means electromagnetic radiation with a wavelength in the range of 10 nm to 400 nm. In some embodiments a UV activated initiator, such as any suitable initiator selected from commercially available compounds known in the art, is included in a formulation with one or more PVGAs suitably functionalized with a UV reactive group. In a representative example, furfural is added to the reaction mixture of glyoxylate derivative and PVOH to form the furfuryl acetal moiety. Then after synthesis and any processing steps desired, irradiation is carried out to effect crosslinking. In embodiments, useful compounds for UV crosslinking of PVGAs include acrylic acid, methacrylic acid, acrolein, pyranaldehyde (acrolein dimer), hex-2-enal, crotonaldehyde, cyclohexene-1-carbaldehyde, cyclopentadiene-2-carbaldehyde, 1-prop-2-enylindole-3-carbaldehyde, cyclopentene-1-carbaldehyde, cycloheptene-1-carbaldehyde, hexa-2,4-dienal, citral, neral, and cyclohexa-1,3-diene-1-carbaldehyde, and the like.

In embodiments, one or more crosslinking reactions are suitably carried out in water. In some embodiments of the invention, a crosslinking agent is added contemporaneously with the glyoxylate derivative. In other embodiments, the crosslinking agent is added in a stepwise fashion, that is, either before or after addition of the glyoxylate derivative. In still other embodiments, internal crosslinking by ester formation is incurred by employing certain reaction conditions during processing of the PVGA. In some such embodiments, some or all of the ester crosslinks are reversed by subsequent addition of a strong base to saponify the ester moieties.

The degree of crosslinking, or crosslink density, employed in the PVGA networks of the invention is selected for the intended end use of the PVGA. Less crosslinking results in a higher absorptive capacity, while more crosslinking results in a higher modulus PVGA hydrogel. In many embodiments, crosslink density is selected for a combination of maximum absorptivity, while preventing the flow of the hydrogel when saturated with an aqueous liquid. Various applications will require varying crosslink density. For example, in some horticultural applications, minimal crosslink density is employed to provide maximum absorptivity because the expected load on the resulting hydrogel is low. However, in some embodiments where the intended end use is a disposable diaper absorbent, somewhat higher crosslink density is required in order to impart the mechanical strength necessary to prevent lateral movement, or elastic deformation, of the swollen polymer particles when the wet diaper is compressed, such as when the baby sits. We have found that when employed in applications where both maximum superabsorptivity and maximum modulus is required, such as in disposable diaper applications, the PVGA of the invention are at least as absorptive as conventional commercial acrylic-based superabsorbents and have a comparable ability to retain liquid under load.

In embodiments, the crosslink density of PVGA is between about 0.001 mole % and 5 mole % of the total number of hydroxyls available in the starting PVOH polymer. In some embodiments, the crosslink density is between about 0.05 mole % and 2 mole % of the total number of hydroxyls available in the starting PVOH polymer. In the disclosures herein it will be understood that where a reaction to form PVGA is discussed, one or more crosslinking agents are optionally included in the reaction substantially as described above; and in embodiments where subsequent processing or application of PVGA is discussed, the PVGA is in some embodiments a crosslinked PVGA.

### Functionalized PVGA

In some embodiments, one or more additional functional compounds are further employed in one or more reactions with the PVOH hydroxyls to impart additional functionality or the desired physical properties to PVGA. Functionalized PVGA are not particularly limited within the scope of the invention. “Additional functional compounds” include, for example, ketones, oxocarboxylates, aldehydes, semialdehydes, epoxides, or carboxylate compounds. In embodiments, carboxylate compounds such as simple esters or carboxylic acids are reacted with hydroxyl groups on the PVOH or PVGA backbone. For example, in one such embodiment, a long chain carboxylic acid such as dodecanoic acid is reacted with hydroxyl groups on the PVOH or PVGA backbone to impart associative crosslinking in a waterbased dispersion of the resulting functionalized PVGA. Pendant amine or hydroxyl functionality is similarly imparted by reaction of PVOH or PVGA hydroxyls with carboxylate functional compounds such as amino acids, lactones, lactams, or hydroxyesters. Other carboxylates similarly are incorporated to achieve the desired functionality or impart certain physical properties (such as a particular range of glass transition temperature, solubility, and the like) to the resulting functionalized PVGA. Ketones, oxocarboxylates, aldehydes, and semialdehydes react with hydroxyl pairs on PVOH or PVGA under reaction conditions suitable to form ketal and acetal functionalities. For example, in some such embodiments, acetone, methyl ethyl ketone, pyruvic acid, acetoacetic acid, levulinic acid, 4-oxobutanoic acid, and derivatives thereof such as esters and salts thereof are useful in conjunction with glyoxylate derivatives in forming functionalized PVGA copolymers of the invention. Useful semialdehydes include any of those disclosed in U.S. Pat. No. 5,304,420. In the disclosures herein it will be understood that where a reaction to form PVGA is discussed, one or more additional functional compounds are optionally included in the reaction and result in formation of a functionalized PVGA; and in embodiments where subsequent processing or application of PVGA is discussed, the PVGA is optionally a functionalized PVGA.

### PVGA Processing: Drying

Some examples of processing steps are described herein; these processing steps are intended to be used in combination with any of the methodology described herein for synthesizing and processing the PVGA materials of the invention. Likewise, the description of physical properties of the SAP materials of the invention are intended to apply to any of the PVGA materials synthesized as described herein and the various forms and morphologies of PVGA and PVGA SAP that result from the processing of the materials. Furthermore, the PVGA and SAP synthesized and processed by such combinations are useful in any one or more formulations and articles of the invention as described herein.

Processing includes, in various embodiments, drying the PVGA polymers of the invention. As used herein, “drying” means removal of water and, in some embodiments, one or more additional solvents so that a total of 5 wt % or less of solvent remains associated with the polymer based on the weight of the polymer, or in some cases based on the weight of the polymer and any additional solid additives such as clays, fillers, residual salt compounds, and the like. Drying of the PVGA is, in embodiments, necessary in order to form a SAP, since the total capacity to absorb aqueous liquids by the PVGA of the invention is necessarily dependent on starting with a dry material. Thus, a “superabsorbent polymer” or “SAP” of the invention is a dry PVGA. In some embodiments, the reaction mixture for forming a PVGA is also dried; however, it is not necessary to fully dry the reaction mixture in order to drive the reaction to completion as is described above. It will be understood that “evaporation of water” as is described above in conjunction with driving the reaction can be, but is not necessarily, “drying” as defined herein.

Drying of PVGA is carried out using conventional techniques. Water and optionally one or more other solvents are removed using known convective or conductive heating devices. The total solvent content of the PVGA after drying will typically be in the range of about 0.1 wt % to 5 wt % based on the weight of the polymer. Fundamentals of the drying process are not limited within the scope of the invention and numerous chemical engineering references are usefully employed to optimize drying conditions. Apparatuses known to be useful in conjunction with drying superabsorbents, such as through-circulation belts, spray driers, and rotating drum dryers, are of utility for drying PVGA. In an alternative embodiment, the drying protocol can optionally be selected to briefly expose surfaces of gel particles to more rigorous drying conditions so that the level of crosslinking via esterification is higher in the areas in proximity to the surfaces. In some embodiments such treatments are employed to obtain a combination of better mechanical properties and good water absorption kinetics.

In various embodiments, drying of the PVGA is carried out before or after additional processing steps in order to form the desired end product form and/or morphology for a particular application. For example, as is discussed above in detail, the reaction of PVOH and glyoxylic derivatives is suitably driven to higher yields by evaporation of water; thus, in many embodiments, at least some portion of the water is removed from a reaction mixture of PVOH and a glyoxylate derivative prior to any further processing such as neutralization and dividing; a second drying step is employed in some such embodiments after neutralization and/or dividing in order to form a SAP, that is, a dry PVGA capable of forming a hydrogel and having SAP behavior.

### PVGA Processing: Dividing

Processing includes, in various embodiments, dividing the PVGA polymers of the invention. As used herein, “dividing” means to separate the PVGA of the invention, or a reaction mixture intended to form such PVGA of the invention, into droplets, mists, discrete solid particles or hydrogel particles, pieces, strips, fibrous shapes, or other shapes in order to provide a form that is useful for one or more applications, or to provide enhanced physical properties such as rate of absorption, or to provide a more efficient means of synthesis and processing of the PVGA. While dividing is not necessary to form a SAP of the invention, dividing generally increases surface area of the resulting SAP and therefore is advantageous in many embodiments of the invention.

In some embodiments, swollen PVGA hydrogel is divided prior to drying by extrusion to form “noodles” or pellets that are further dried using a combination of reduced pressure and heat to obtain substantially dry thermoset. In some such embodiments, the dried pellets are further divided, for example by grinding or milling, and the particles are sized by sieving or another means known to those of skill. In other embodiments, a reaction mixture for forming a PVGA is divided prior to completion of the reaction by dripping, spot coating, gravure coating, or spraying onto a surface, where the divided reaction mixture forms PVGA. In some embodiments, the surface is made of a material having low adhesion with PVGA, for example of a perfluorinated polymer or silicone polymer. In some such embodiments, and as is described above, the surface is a heated substrate such that reaction and evaporation of water take place contemporaneously. Evaporation of water includes, in some embodiments, fully drying the divided reaction mixture. As described above, the heated substrate temperature is between 30° C. and 180° C., for example between 90° C. and 160° C. After reacting and optionally fully drying, the PVGA thus formed is removed from the surface. In some such embodiments, a dry particulate of uniform size is recovered from such processes. In some such embodiments, a crosslinking agent is added to the divided reaction mixture after dividing but before completion of the reaction; in such embodiments, additional crosslinking is carried out substantially on the exposed surface of the divided reaction mixture and/or the divided PVGA as it forms.

In some embodiments, components of the PVGA are combined and then coated onto a particular substrate prior to completion of the reaction; the reaction is completed in situ on the coated substrate, for example by heating to evaporate some of the water, or alternatively to dry the reacted mixture. In such embodiments, completion of the reaction in situ results in a uniform, continuous coating having excellent cohesive properties and in some embodiments, excellent adhesion to the coated substrate. While in principle any substrate can be so coated, we have found that substrates including cellulosic polymers, polyamides including nylon polymers, polyesters including polylactic acid polymers, and glass and other silica or clay based materials provide good adhesion to the PVGA of the invention when coated in such a manner. The substrate may be a relatively uniform, monolithic surface such as a glass plate or sheet or web of paper; or it may be a fiber or a particle. Coating is accomplished using any known coating technique, depending on the nature of the substrate to be coated as will be appreciated by one of skill. Useful coating techniques include dip coating, roll coating, gravure coating, spray coating, nip coating, die coating, flood coating, and the like. In embodiments, after coating and completing the PVGA reaction in situ, coated substrates are divided. In some embodiments, dividing is carried out after drying the PVGA; in other embodiments, partial drying or no drying is carried out prior to dividing. In various embodiments, coated fibers are carded or chopped; coated particles are dried and de-agglomerated; coated woven or nonwoven fabrics are cut into sections; and the like. In some embodiments, paper substrates are coated with PVGA reaction mixtures, the reaction to form PVGA is completed in situ, and the coated paper is cut into strips. One or both sides of a paper substrate are so coated in various embodiments.

In some embodiments, coating and reacting the PVGA on a substrate is followed by removing the PVGA from the substrate to yield a freestanding PVGA in a selected shape. For example, coating a silicone or polytetrafluoroethylene (PTFE) belt surface with a uniform coating of PVGA reaction mixture and reacting the mixture, following by removal of the coating from the silicone or PTFE surface, results in a sheet of PVGA. Drying in such embodiments is carried out either before or after removal of the sheet from the silicone or PTFE surface. In some embodiments, an embossed or microembossed silicone belt is coated, and the reacted and optionally dried PVGA sheet having a pattern embossed therein is removed from the embossed or microembossed silicone belt. Alternatively, the embossed silicone belt has individual wells that are filled with PVGA reaction mixture by coating, for example nip coating; after forming the PVGA, divided “particles” having a defined shape are removed from the wells of the embossed silicone belt. Drying after removal from the wells results in a reduction in the size of the “particles” with retention of the shape.

In some embodiments, the particle size of the SAP of the invention is adjusted after drying to place the SAP in suitable form for one or more applications. In embodiments, two-stage milling is employed with the SAP in combination with screening and recycling of the oversize stream back into the milling step. The combination of milling and screening are used, in various embodiments, to achieve particle sizes averaging between about 100 μm and 1 mm. Other processes and equipment known in the art to produce particles in a variety of size ranges and varying degrees of uniformity are also suitably employed. The PVGA of the invention are not particularly limited by particle size; however, it will be understood by one of skill that a smaller particle size results in a faster rate of absorption of aqueous liquids by the finished SAP particles, because of increased available surface area. Particle size of the PVGA of the invention range, in various embodiments, from 50 nm to 3 mm, or about 1 μm to 2 mm, or about 10 μm to 1 mm. Particles are divided either before or after drying. In some embodiments, dividing before drying provides an advantage in that subsequent drying and particle shrinkage offers an easy method to form controlled particle sizes of a uniform size range.

### PVGA Processing: Washing

In various embodiments, prior to drying the PVGA, the PVGA are subjected to a washing step. Washing is not a requirement in order to employ the PVGA of the invention as SAP: excellent SAP properties are incurred by forming, neutralizing, and drying the PVGA using any of the techniques described above. However, in many embodiments, removal of impurities, reduction in soluble impurities, reduction in the overall yield loss in the PVGA synthesis, and formation of unique surface morphology is imparted by washing the PVGA of the invention to provide a SAP that is ideally suited for one or more applications. In embodiments, water is useful to wash excess base from the neutralization step, unreacted glyoxylate derivative, or other impurities from the PVGA. However, due to the large absorption capacity of the PVGA realized after neutralization, water washing can only be accomplished by using large amounts of water relative to the amount of PVGA. Thus, water washing requires, in some embodiments, wt/vol ratios of polymer to water of 3/97, as high as 1/99, or even as high as 0.1/99.1 in order to incur effective washing.

We have found that subjecting PVGA compositions, optionally in the form of fibers, sheets, coatings, or particles, to an aqueous solvent wash imparts improved kinetic performance, that is, the rate of uptake of water and aqueous solutions by the resulting SAP of the invention. Further, an aqueous solvent wash has been found to significantly lower the amount of soluble material in the PVGA composition, thereby reducing overall yield losses due to washing out some of the material. As used herein, the term “aqueous solvent” means a water miscible solvent or a mixture of water and a water miscible solvent, wherein the water miscible solvent is a compound that is a liquid and is miscible with water over at least some range of volumetric mixtures between about 15° C. and 30° C. In embodiments, aqueous solvent mixtures are miscible over a range or portion of a range that is about 1:99 to 99:1 vol:vol water:solvent, or about 10:90 to 90:10 vol:vol water:solvent, or about 20:80 to 80:20 vol:vol water:solvent, or about 30:70 to 70:30 vol:vol water:solvent, or about 40:60 to 60:40 vol:vol water:solvent. Suitable solvents include, for example, lower alcohols such as methanol, ethanol, isopropanol, n-propanol, and isobutanol; diols such as ethylene glycol, diethyleneglycol, or propanediol; triols such as glycerol; ketones such as acetone or methyl ethyl ketone; lower esters of carboxylic acids such as ethyl or methyl formate; and other water miscible compounds having one or more heteroatoms such as tetrahydrofuran, dimethylsulfoxide, dimethylformamide, ethanolamine, diethanolamine, dioxane, pyrazine, pyrrole, ethyl pyruvate, and the like. Individual water miscible solvents or mixtures thereof can be used in the aqueous solvent wash. The aqueous solvent wash fluid can optionally contain added plasticizers, surfactants, humectants, anti-oxidants, colorants, or other formulation components desirably contacted with the PVGA. In embodiments, ethanol or isopropanol are employed as the solvent in an aqueous solvent mixture. In embodiments, ethanol:water or isopropanol:water at 50:50 to 90:10 vol:vol ratios, or 70:30 to 80:20 vol:vol ratios are suitably employed as the aqueous solvent mixture composition for some PVGA compositions of the invention. In other embodiments, a SAP swollen in the absence of organic solvent to full or partial capacity with water or aqueous base is then subjected to washing with a water miscible solvent alone. In such embodiments, the solvent mixes with the water present in the hydrogel to displace a portion of it and thus the aqueous solvent solution is formed in situ.

In embodiments, the aqueous solvent wash is employed to wash the swollen PVGA after synthesis and optional formation of the particle, sheet, coating, or fiber, but before drying. In other embodiments, the aqueous solvent wash is employed to wash the PVGA after synthesis, but before optional formation of the particle, sheet, coating, or fiber. In embodiments, the aqueous solvent wash composition is optimized, in terms of the solvent employed and the ratio of solvent to water, to minimize the degree of swelling of the PVGA in the presence of the aqueous solvent wash. In embodiments, fully swollen PVGA hydrogels containing about 1 wt % or less of total solids, in some embodiments between 1 wt % and 0.05 wt % solids, subsequently exposed to the aqueous solvent composition contract to contain a total of at least about 3 wt % solids upon decanting of free—that is, unentrained—aqueous solvent mixture from a swollen PVGA mass. For example, the contracted PVGA hydrogels contain between about 3 wt % and 20 wt % solids, or between about 5 wt % and 15 wt % solids upon decanting of free aqueous solvent mixture from a swollen PVGA mass.

In embodiments, subjecting a PVGA of the invention to an aqueous solvent wash causes improvements in properties and performance of the resulting PVGA material once dried. For example, in some embodiments, PVGA subjected to an aqueous solvent wash has a lower amount of water soluble content when compared to the same PVGA washed by water alone. For example, % soluble content of PVGA subjected to aqueous solvent wash contains, in some embodiments, less than 30 wt % water soluble content, for example about 0.01 wt % to 20 wt % water soluble content, or about 0.5 wt % to 15 wt % water soluble content, or about 1 wt % to 10 wt % water soluble content. In embodiments, PVGA subjected to an aqueous solvent wash has a higher initial rate of water and aqueous liquid uptake in the PVGA when compared to the same PVGA washed by water alone. The initial rate of absorption of aqueous liquids is strongly affected by subjecting the PVGA to an aqueous solvent wash, followed by drying to form a SAP, when compared to unwashed SAP or SAP washed in water alone. As used herein, “initial rate of absorption” means the rate of aqueous liquid absorption, in grams of liquid per gram of dry SAP per minute, absorbed in the first 10 seconds to 30 seconds after contact of the dry SAP with the liquid. A plot of weight of liquid absorbed vs. time can be used to interpolate this rate; though it will be understood that for a rapidly absorbing SAP, the accuracy of initial rate measurements are limited by the time it takes to remove a SAP sample from a test liquid and blot away residual interstitial water before that excess liquid is absorbed. Within that limitation, we have observed that in various embodiments SAP subjected to an aqueous solvent wash prior to drying have an initial rate of aqueous liquid absorption of at least about 1.5×, for example about 1.5× to 25×, or about 2× to 10×, or about 3× to 7×, greater than the same SAP synthesized and processed in the same way but washed with water alone. In embodiments, the time required for a dry, aqueous solvent washed SAP of the invention to reach one-half of the maximum absorption capacity of a solution of 0.9 wt % NaCl at about 20° C.-27° C. is about half that of the same SAP washed with water only, or about one third that of the same SAP washed with water only, or one-fifth that of the same SAP washed with water only.

Surface area is the means by which a solid interacts with its environment. As it relates to the SAP articles of the invention, surface area correlates strongly to the initial rate of absorption of aqueous liquids. In one sense, surface area is the “apparent surface area”, that is, surface area calculated by employing gross dimensions such as average particle size, coated surface area for a coating, or fiber size. Sizing measurements known in the art are useful in calculating the average apparent surface area of particles or fibers of a general shape (spherical, oblong, cylindrical), for example. For irregular particles, radius of gyration for one known dimension—for example gross particle size determined by sieving—is sometimes employed to describe the apparent surface area. As average particle or fiber size decreases, the apparent surface area per unit volume (or mass) increases. Very coarse particles and fibers have an apparent surface area as low as a few square centimeters per gram, while finer particles or fibers have an apparent surface area of a few square meters per gram.

The presence of fine surface features on a particle, coating, or fiber can produce actual surface area far in excess of that of the apparent surface area. Actual surface area corresponds to porosity and/or the roughness of the surface, that is, bumps, folds, creases, striations, and the like. In forming a hydrogel, the rate of uptake of aqueous liquids by a SAP is strongly influenced by the ratio of actual surface area to apparent surface area. In embodiments, the aqueous solvent washing of a PVGA hydrogel leads to the formation of a unique surface morphology, described herein as “convoluted” morphology, wherein convoluted surface features are imparted to the SAP of the invention by the aqueous solvent washing procedure described above. Without wishing to be constrained by theory, we believe both the increased surface area itself, as well as the particular type of surface morphology imparted by the aqueous solvent wash are directly correlated to the observed increase in initial rate of absorption by the SAP of the invention. Any of the PVGA of the invention, as described above, can have such features imparted to a surface thereof when the PVGA is dried to form a SAP. However, it will be understood that the method of employing an aqueous solvent wash to any hydrogel including a polymer that is a SAP when dried, is suitably subjected to the method of subjecting the hydrogel to an aqueous solvent wash, followed by drying, to impart the surface features thereto. The same benefit of markedly improved initial absorption rate of aqueous liquids is imparted to any SAP subjected to an aqueous solvent wash of the corresponding hydrogel.

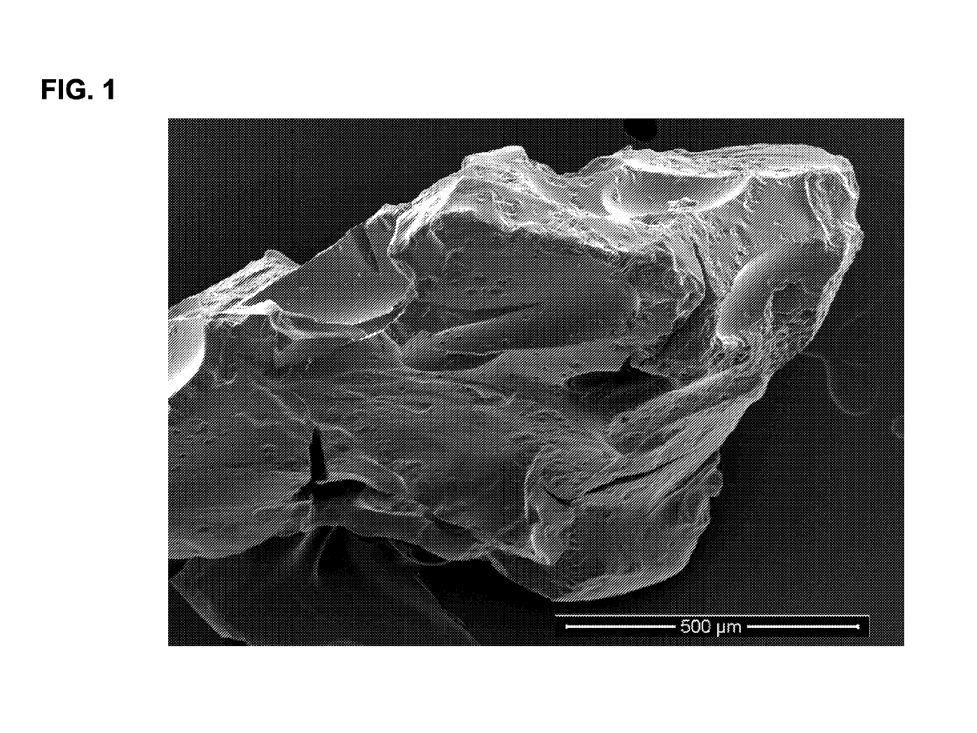

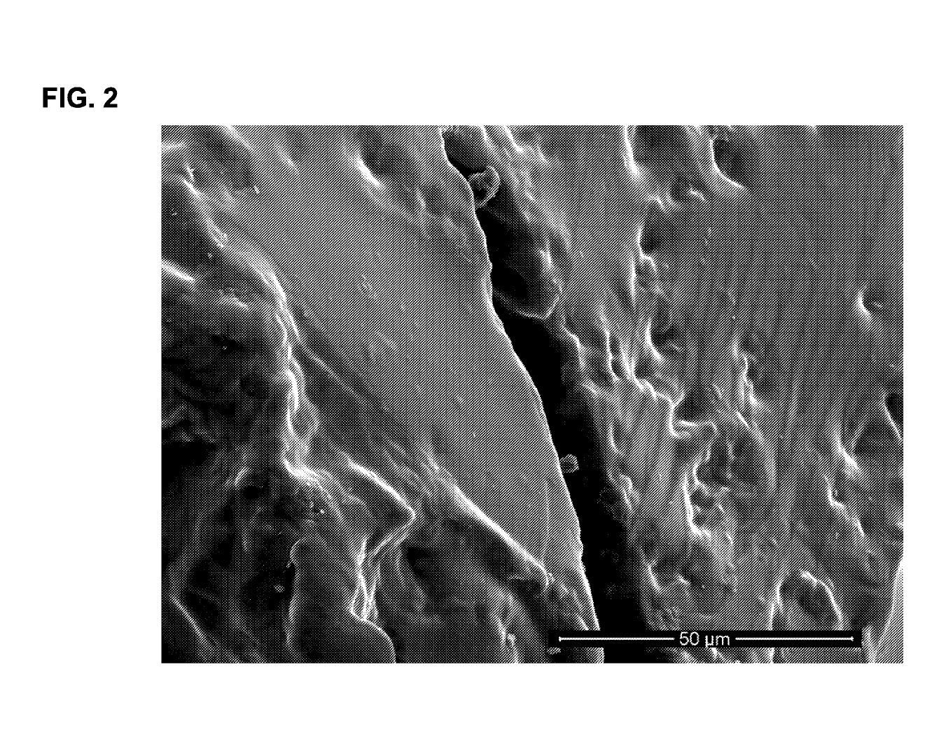

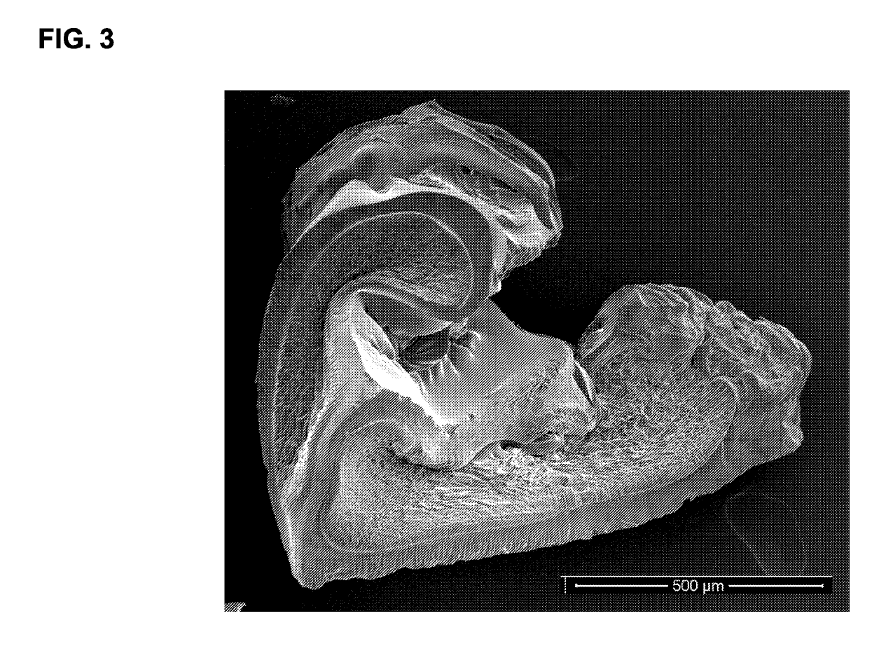

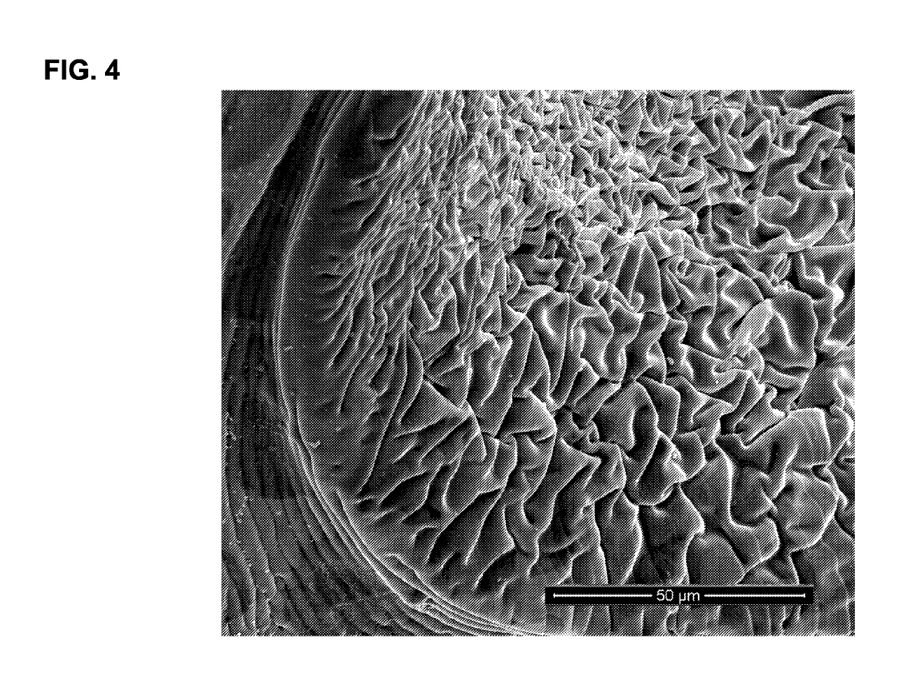

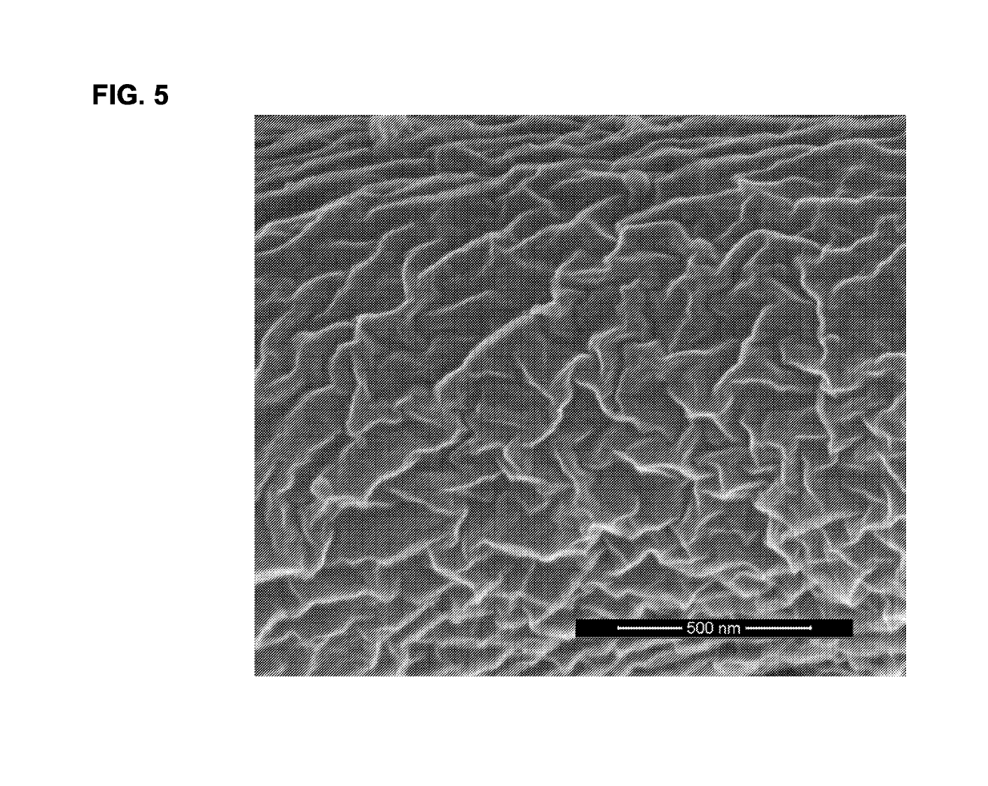

The convoluted surface morphology will now be described in detail. Referring to FIG. 1, a SAP of the invention is shown at 100×. The SAP includes a PVGA of the invention, wherein the PVGA was swollen to capacity with deionized water and then subjected to a water wash prior to drying. The PVGA was divided by grinding prior to washing with water. The surface is shown in more detail in FIG. 2, which is the same particle magnified to 1000×. While surface irregularities such as roughness and pitting are visible, the bulk of the surface is relatively featureless. In contrast, the same PVGA, ground and dried, was swollen to capacity with water and then washed twice with ethanol before drying. FIG. 3 shows a representative particle after the ethanol wash, at 100×. The surface is shown in more detail in FIGS. 4 and 5, which is the same particle shown at 1000× and 75,000×, respectively. The features present on the surface of the particle are convoluted surface features. As it is defined above, “convoluted” means folded in curved or tortuous windings; furrowed, wrinkled, fissured, or grooved. This surface morphology increases the specific (actual) surface area of the SAP articles in a manner that translates to the rapid rate of uptake of aqueous liquids by the dry SAP articles.

The convoluted surface features differ in size depending on the chemical nature of the PVGA, aqueous solvent wash employed, and method of washing. Size of the folds or creases of the convoluted surface features differ, in various embodiments, in terms of average height—that is, peak to valley distance (analogous to amplitude)—and average periodicity—that is, peak-to-peak or valley-to-valley distance (analogous to frequency). In embodiments, the convoluted surface features have heights of between about 10 nm and 25 μm, and periodicity of about 10 nm and 50 μm. In embodiments, varying the type of solvent, solvent:water ratio in one or more successive washes, and the manner in which the solvent is introduced to the swollen SAP particles causes variation in the resulting convoluted surface morphology. For example, particles immersed in a large volume of water in addition to the amount required to fully swell the hydrogel and then subjected to a slow drip of a fully water miscible solvent exhibits, in some embodiments, gradual shrinkage. For another example, particles immersed in less than the amount of water required to swell the particles to capacity and then subjected to a rapid addition of the water miscible solvent alone exhibits, in some embodiments, rapid shrinkage. These two variations give rise to variations in the observed surface morphology in terms of the height and periodicity of convolutions in addition to the degree of macroscopic shrinkage of the particles.

In some embodiments, SAP particles have the convoluted surface morphology over at least 10% of the surface thereof, for example between 10% and 100% thereof, or between about 25% and 75% thereof. In other embodiments, SAP coatings are formed as described above and subjected to an aqueous solvent wash after coating. In such embodiments the convoluted surface morphology is present over at least 10% of the surface thereof, for example between 10% and 100% thereof, or between about 25% and 75% thereof. In still other embodiments, freestanding SAP sheets or fibers are formed and subjected to an aqueous solvent wash; such SAP sheets or fibers have the convoluted surface morphology over at least at least 10% of the surface thereof, for example between 10% and 100% thereof, or between about 25% and 75% thereof.

Additional particle features imparted by the aqueous solvent wash are visible when comparing FIG. 1 and FIG. 3. FIG. 3 shows a particle that has an overall curved, folded, collapsed appearance that is in addition to the convoluted surface features. In some areas of the particle, creases and hollowed voids are visible. Without being limited as to theory, we believe that the collapsed appearance of the particle in FIG. 3 arises as a direct result of the aqueous solvent wash, that is, the entire particle shrinks in the presence of ethanol. This is borne out by data which show that the volume of the particles when swollen to capacity in water is reduced by as much as 10× to 300×, or about 50× to 100× when subjected to subsequent aqueous solvent wash. In some embodiments the collapsed shape of the particles further enhance the rate of aqueous liquid absorption by contributing to capillary pressure upon contact with the liquid. In some embodiments, such shapes form structures that are porous. Porous features, that is, holes or cavities progressing from the surface to the interior of the particle or coating, (as differentiated from the convoluted features) are present in some embodiments of the PVGA SAP of the present invention. A complete discussion of porous hydrogels, including SAP and superporous hydrogels, is found in Omidian, H. et al., J. Controlled Release 102, 3-12 (2005).

Without being limited by theory, we believe that the convoluted surface features represent a particularly advantageous morphology for the purposes of SAP performance. While traditionally porous particulates are considered to be advantageous from the standpoint of providing capillarity to solid particles, for a SAP particle a porous morphology is not ideal. This is because a SAP swells to many times its dry size very quickly in the presence of liquid; in many cases, a porous particle would simply swell so as to quickly close off the pores. Convoluted surface features, on the other hand, provide a large effective surface area for contact with liquid and, when swelling is initiated, unfurl to contact additional liquid.

In some embodiments, convolutions are directionally oriented, patterned. In other embodiments convolutions are not oriented or patterned. Orientation or patterns arise, in some embodiments, where a directional water miscible solvent or aqueous solvent mixture is flowed over a hydrogel particle or coating; or where a PVGA hydrogel particle or coated substrate is dragged over a surface that is wetted with a water miscible solvent or an aqueous solvent mixture; or where the hydrogel is disposed as a thin coating on a patterned substrate surface or on a substrate surface having a particular morphology, for example a fiber or a natural cellular tissue structure of cellulosic material or of any other such substrate.

Actual surface area measurements are made using one of several known techniques. For example, the temperature and pressure of an inert gas can be adjusted to cause a single layer of gas molecules to be adsorbed over the entire surface of a solid, be it porous, non-porous, or powdered. Pressure transducers or other sensors known to those of skill respond quantitatively to the amount of gas adsorbed. B.E.T. adsorption and mercury porosimetry are two such known techniques by which adsorption data are gathered See, for example: Brunauer, S. et al., J. Am. Chem. Soc., 60 (2), 309-319 (1938); Abell, A. et al., J. Coll. and Int. Sci., 211, 39-44 (1999). Using these data, it is possible to compute the actual surface area of a sample, which is usually reported as the specific surface area: surface area per unit mass, usually m²/g. The ratio of specific surface area to apparent surface area based on average particle size, average fiber size, or coated surface area is called, for the purposes of the invention, the “surface area ratio.” Using mercury porosimetry, for example, the ratio of measured surface area of water washed to aqueous solvent washed SAP particles of the invention is about 1:1.5 to 1:25, or about 1:2 to 1:10, or about 1:3 to 1:7. In embodiments, the total surface area for aqueous solvent washed particles, as measured using mercury porosimetry or B.E.T., is about 10 m²/g to 400 m²/g.

### SAP Performance

In embodiments, the PVGA networks are superabsorbent with respect to water. In some embodiments, the PVGA SAP absorbs between about 20 g and 500 g of deionized or distilled water per gram of dry polymer at temperatures of about 20°-27° C. In other embodiments, the SAP absorbs between about 40 g and 300 g of deionized or distilled water per gram of dry polymer at temperatures of about 20°-27° C. The SAP of the invention are also superabsorbent with respect to aqueous liquids. As used herein, “aqueous liquid” includes water, NaCl solutions of varying concentrations, waterbased solutions and dispersions from body fluids such as urine, plasma, or blood, or other waterbased solutions and dispersions such as medical fluids including drug bearing fluids, fluids emanating from food, aqueous waste effluents, and the like. The aqueous liquid is not particular limited. In many embodiments, a waterbased dispersion is absorbed only as to the water and water soluble components, wherein dispersed components are then simply immobilized. In embodiments, the SAP of the invention absorb between about 4 g and 200 g of aqueous liquid per gram of dry polymer at temperatures of about 20° C. In other embodiments, the SAP absorb between about 10 g and 50 g of aqueous liquid per gram of dry polymer at temperatures of about 20° C.

In embodiments, the PVGA SAP also absorb aqueous liquid rapidly, which enables their utility in a number of industrial applications. In some embodiments, at temperatures of about 20°-27° C., a SAP having water content of less than or equal to about 5 wt % based on the weight of the polymer absorbs its own weight of water in about 1 second to 100 seconds. In other embodiments, a SAP absorbs its own weight of distilled or deionized water in about 10 seconds to 80 seconds. In still other embodiments, a SAP absorbs its own weight of water in about 20 seconds to 50 seconds. In embodiments, the initial rate of absorption of a solution of 0.9 wt % NaCl by a dry PVGA SAP at 20°-27° C. is about 1 to 30 g NaCl solution per g PVGA per minute (g/g·min), or about 4 to 20 g/g·min, or about 5 to 20 g/g·min, or about 5 to 15 g/g·min. In embodiments, the time required for a dry PVGA SAP of the invention to reach one-half of the maximum absorption capacity of a solution of 0.9 wt % NaCl at about 20°-27° C. is about 30 seconds to 15 minutes, or about 0.8 minutes to 9 minutes, or about 1 minute to 3 minutes.

As is discussed in detail above, convoluted surface morphology enhances the initial rate of absorption of the SAP.

### SAP Formulations and Applications

Some examples of formulations, applications, and articles including the SAP and hydrogels of the invention are described in this section; the formulations, applications, and articles are intended to be used in combination with any of the methodology described herein for synthesizing and processing the PVGA materials of the invention. Furthermore, the PVGA and PVGA SAP materials synthesized and processed by such combinations are useful in any one or more formulations, applications, and articles of the invention as described in this section or the sections above.

It will be appreciated that in many useful applications, the SAP particles, sheets, coatings, or fibers formed as described herein are one component of a formulation that is optimized for the particular end use. In some such applications the SAP particles, coatings, or fibers are a major component of the formulation; in other applications they are a minor component. In other embodiments, one or more formulation components are entrained within the SAP itself, for example within a SAP particle or coating. Examples of useful formulation components include, in various embodiments, solvents, aqueous liquids, aqueous solvent mixtures, cellulose, starch, lignin, polysaccharides, surfactants, clays, mica, drilling fluids, insecticides, herbicides, fertilizers, fragrances, drugs, fire-retardant agents, personal care formulation components, coating additives, cyclodextrins, fillers, adjuvants, thermal stabilizers, UV stabilizers, colorants, acidulants, metals, microorganisms, spores, encapsulated organic acids, or a combination thereof.

The SAP described herein, and formulations derived from the SAP, are useful in many applications in which superabsorbents have already enjoyed commercial utility. The SAP of the invention are useful as absorbents in personal disposable hygiene products, such as baby diapers, adult protective underwear and sanitary napkins. SAP particles, fibers, or coatings are also useful in applications including, for example, blocking water penetration in underground power or communications cable; as horticultural water retention agents; as carriers in drug delivery systems including as coatings for drug-eluting stents or as reservoirs in topical drug delivery, including delivery by ionophoresis; for control of spill and waste aqueous fluids; as absorptive coatings for inkjet inks or other aqueous based paints, inks, or colorant compositions; as carriers for controlled release of insecticides, herbicides, fragrances, and drugs; as fire-retardant gels; in mortuary pads, surgical pads, wound dressings, and for medical waste solidification; in absorbent pads and packaging materials for comestibles; as gel additives in cosmetics; in sealing composites; in filtration applications; in fuel monitor systems for aviation and motor vehicles; as a drown-free water source for caged insects; as an additive for masking tape designed for use with latex paint; in hot/cold therapy packs; in motionless waterbeds; in grow-in-water toys; as additives in drilling fluids, and as artificial snow for motion picture and stage production. In some embodiments, the PVGA particles, fibers, sheets, and coatings as well as formulations formed therefrom are useful as the swollen hydrogels for one or more applications. Such applications include, for example, scaffolds in human tissue engineering, wherein in some embodiments human cells are included within the PVGA matrix; in drug delivery systems including as coatings for drug-eluting stents or as reservoirs in topical drug delivery, including delivery by iontophoresis; for controlled release of insecticides or herbicides; in EEG and ECG medical electrodes; in breast implants; as horticultural water retention agents; and as dressings for healing of burns or other hard-to-heal wounds. It will be appreciated that in many useful applications, the swollen PVGA particles, coatings, or fibers are one component of a formulation that is optimized for the particular end use. In some such applications the swollen PVGA particles, coatings, or fibers are a major component of the formulation; in other applications they are a minor component.

The SAP and hydrogel materials of the invention are also usefully combined with one or more formulation components, in some embodiments, to boost water absorption capacity, rate of water absorption, or both. For example, in some embodiments, one or more surfactants blended with PVGA increase the rate of water absorption of the resulting SAP. In embodiments, addition of clay and mineral fillers, such as silica clay and microtine mica, are employed to increase the comprehensive water absorbing properties of the SAP. Other materials, such as starch, cellulose, inorganic fillers such as titanium dioxide or carbon black, zeolite or porous carbon, plant fibers, ground plant fibers, and the like are usefully combined with the SAP of the invention, as dictated by the end use application.

Because of its absorption capacity without load and under load, as well as excellent absorption rate, PVGA SAP of the present invention can be used as a direct replacement of acrylic-based SAP materials known in the art and widely used in practice.

### Degradation of PVGA Hydrogels

The PVGA SAP of the present invention combine the absorption capacity and absorption rate necessary for such high demanding applications as baby diapers with the ability of the swollen—that is, used—hydrogels to undergo a variety of chemical and biological reactions ultimately leading to the innocuous biodegradable products, hereby in principle permitting complete degradation of e.g. spent and disposed consumer items under appropriate environmental conditions. Any of the PVGA materials, including PVGA SAP described herein, synthesized and processed using any of the methodologies described herein, exhibiting any combination of physical properties as described herein, and employed in any of the formulations, applications, and articles as described herein are degelled and/or degraded, in various embodiments, using any combination of the methods described in this section.

The degradation process of PVGA under environmental conditions can, for example, include hydrolytic reactions resulting from a deacetalization and/or ester hydrolysis reaction. The deacetalization of acetals and/or hydrolysis of ester groups, for example those formed by the crosslinking reaction of glyoxylate carboxylates with residual PVOH hydroxyls as described above, results in gradual de-crosslinking and degelling of the PGVA hydrogel. Deacetalization of cyclic glyoxylic acetal moieties results in the release of glyoxylic acid and its salts and decreased acetalization of PVOH.

As used herein, “degelling” means causing a PVGA hydrogel to become sufficiently dispersible in water or an aqueous liquid that the dispersion appears homogeneous and wherein at about 20°-27° C., a waterborne dispersion of the degelled material passes through a paper filter having a particle retention capacity of 1-5 μm and a Hertzberg flow rate of 1400 seconds. In embodiments the SAP hydrogels of the invention, swollen partially or to full capacity with aqueous liquids, are degelled using mild conditions.

Hydrolytic deacetalization requires acidic conditions. In some embodiments, contacting the PVGA hydrogels with an acid, preferably a water soluble acid, results in the reduction of gel content and concomitant appearance of glyoxylate derivatives over a period of about 1 to 180 days with the constant presence of water entrained in the hydrogel. For the purposes of the invention, acidic compounds effective in causing degelling of the PVGA hydrogels are called “acidulants.” A single acidulant or a combination of one or more acidulants as described herein is used to degel the PVGA hydrogels of the invention. In some embodiments, the acidulant is a weak organic acid. As used herein, “weak organic acid” means a carboxylic acid having a pKa of at least 2. In some embodiments, citric acid, succinic acid, malic acid, fumaric acid, itaconic acid, lactic acid, O-lactoyllactic acid, or acetic acid is employed as the acidulant. Phosphoric acid and monobasic salts thereof are also suitable acidulants; however, they are less preferred due to possible environmental pollution associated with release of highly soluble phosphates. In embodiments, sufficient acidulant is contacted with the hydrogel to form a liquid environment within the swollen PVGA hydrogel having a pH of about 2 to 6, in embodiments a pH of about 2 to 5, which in turn is sufficient to cause degelling of a PVGA hydrogel over a period of about 1 to 180 days. The specific amount of weak organic acid required to reach the targeted pH will be different depending, for example, on the nature and volume of the aqueous liquid absorbed by the PVGA, the number of glyoxylic acetal repeat units, and degree of neutralization of the glyoxylate carboxyl groups. In some embodiments, a major fraction of the PVGA hydrogel becomes fully dispersible or soluble in water over a period of 180 days or less after contacting the swollen hydrogel with a weak organic acid.

In some embodiments, citric acid is contacted with a PVGA swollen to capacity with water or 0.9 wt % NaCl. In such embodiments, upon adjusting the pH to between 3 and 4 with citric acid, the swollen PVGA hydrogel begins to degel upon contact with the acid such that within 10 days, about 30 wt % to 60 wt % of the swollen hydrogel becomes sufficiently dispersible to pass through a paper filter having a particle retention capacity of 1-5 μm and a Hertzberg flow rate of 1400 seconds. After about 20 days, about 50 wt % to 80 wt % of the swollen hydrogel is dispersible as described above, and after about 45 days, about 65 wt % to essentially all of the swollen hydrogel is dispersible as described above. In many embodiments, essentially all of the swollen hydrogel is dispersible as described above after about 90 days. Compared to the citric acid treated hydrogel, in some embodiments a water swollen hydrogel becomes about 20 wt % or less dispersible as described above after about 45 days.

The acidulant is made available to contact the PVGA hydrogel in one or more of a number of available forms. In some embodiments where the aqueous liquid contacting the SAP to form the hydrogel is itself an acidulant, no further additional steps or formation is required. In other embodiments, the acidulant is supplied in dry form, such as by acidulants that are solids at temperatures below about 40° C. or higher. In such embodiments, the acidulant is dissolved or partially dissolved when the SAP is contacted with aqueous liquid, thereby imparting the necessary pH range for degelling. In other embodiments, an acidulant is provided in an encapsulated form to provide for a latent release of acidulant into the hydrogel after the SAP is swollen with aqueous liquid, that is, upon use, or after an article including the hydrogel has been disposed. For example, particles including an acidulant can be coated with gelatin, starch, PVOH, poly(vinyl acetate), poly(vinylpyrrolidone) or other coating compositions known in the art that are known to slowly dissolve or otherwise decay over the periods of several days after the time of exposure to moisture associated triggering the formation of hydrogel from dry PVGA. In still other embodiments acidulants are latent acidulants, that is, the acidulant is supplied in a precursor form such as carboxylic acid ester or polyester capable of hydrolysis when exposed to an aqueous liquid. Examples of latent acidulants are lactide, ester polymers and oligomers and copolymers of lactic, citric, succinic, fumaric acids and the like. In some such embodiments the latent acidulant is encapsulated in a manner similar to that described for the encapsulation of acidulants.

Acidulants, including encapsulated acidulants and latent acidulants, are contacted with the PVGA hydrogels using one or more of a number of methods. In some embodiments an acidulant is incorporated within a formulation containing the SAP. In some such embodiments an acidulant is incorporated within the SAP itself, for example in a coating. In other embodiments an acidulant is situated proximal to the SAP in an article, such that when an aqueous liquid contacts the SAP it also contacts the encapsulated acidulant. In still other embodiments, the acidulant is a coating, for example a powder coating, that adheres to dry SAP particles. Latent acidulants that are polymeric are also employed in some embodiments in the form of a film or a fiber or as an integral part of an article including the SAP of the invention.

In addition to the hydrolytic reactions leading to the formation of free glyoxylate derivatives and partially or completely deacetalized PVOH, PVGA hydrogels are amenable to a variety of oxidative reactions under mild conditions, including conditions resembling those arising from action of certain enzymes known in the art to be produced by various lignolytic fungi. For example, dilute solutions of inorganic peroxides such as hydrogen peroxide and periodates, for example sodium periodate, degel the hydrogels of the invention. Suitable metal catalysts include, for example, those based on Co²⁺, Cu²⁺, Mn²⁺, Mn³⁺, and Fe²⁺. Without being limited by theory, we believe such oxidation reactions involve, for example, the acetalized carbon atoms of the glyoxylic acetal moieties, thereby resulting in the oxidative deacetalization with the presumed formation of oxalate; the oxidations can also involve the methine and methylene groups of acetalized PVOH, thereby resulting in the formation of a complex mixture of possible products, including but not limited to free glyoxylic derivatives, ketone groups in the polymer backbone, and various carbon-carbon scission products (oxidative and/or hydrolytic) resulting in an overall reduced degree of polymerization.

The PVGA of the invention, in embodiments, are assembled from intrinsically biodegradable starting materials via formation of cyclic and acyclic acetal bonds between hydroxyl groups of PVOH and aldehyde group of one or more glyoxylate derivatives, as well as via the formation of additional linkages such as the crosslinking ester bond between the carboxyl group of the glyoxylate derivative and a hydroxyl group of PVOH. PVOH is known in the art to be intrinsically biodegradable under appropriate environmental conditions (See, e.g. Chiellini, E. et al., Prog. Polym. Sci. 28, 963 (2003). Glyoxylic acid and glyoxylate salts are natural products and readily utilizable central metabolites occurring in a majority of life forms on Earth as part of glyoxylate shunt of the Tricarboxylic Acid Cycle (TCA).

Certain microorganisms capable of degrading wood and other cellulosic biomass residues are of particular utility for achieving favorable conditions for significant or complete degradation of PVGA hydrogels. For example, many lignolytic fungi are well known to produce a mixture of enzymes with powerful capacity to oxidize and degrade a plethora of organic substrates. Among such enzymes are manganese peroxidase, glucose oxidase producing hydrogen peroxide, lignin peroxidase, and laccase. Non-limiting examples of such useful microorganisms include Pleurotus, Naematoloma, Phanerochaete, Lentinula, Flammulina, Trametes spp., as well as many other representatives of Basidiomycota and Ascomycota, including some edible varieties of mushrooms. Biological and chemical oxidation reactions due to activity of white, brown and soft rot fungi are of practical utility for achieving the desired degradative effect on the PVGA hydrogels. Such reactions can take place when PGVA of various degrees of acetalization or PVOH is presented for conditions favoring growth of such fungal species, for example under composting conditions comprising PVGA hydrogels and woody or other ligninaceous biomass residues.

In some embodiments, in order to facilitate the onset of successful colonization of disposed articles comprising PVGA hydrogels with desired microorganisms, inoculae of such microorganisms are introduced to compost heaps, or the articles comprising PVGA SAP are equipped with tablets or granules of viable but dormant spores or mycelia of fungi or bacterial cells in an encapsulated form. For example, they can be coated with gelatin, starch, PVOH, poly(vinylacetate), poly(vinylpyrrolidone) or other coating compositions known in the art that are known to slowly dissolve or otherwise decay over the periods of several days after the time of exposure to moisture associated triggering the formation of hydrogel from dry PVGA.

Various exemplary embodiments are described in detail below. Reference to various embodiments does not limit the scope of the claims attached hereto. Additionally, any examples set forth in this specification are not intended to be limiting and merely set forth some of the many possible embodiments for the appended claims.

“About” modifying, for example, concentration, volume, process temperature, process time, yield, flow rate, pressure, the quantity of a compound or ingredient in a formulation or in an article, number of repeating organic units in a polymer, and like values, and ranges thereof, employed in describing the embodiments of the disclosure, refers to variation in the numerical quantity that can occur, for example, through typical measuring and handling procedures used for making compounds, compositions, concentrates, use formulations, or articles; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a reaction or a formulation with a particular initial concentration or mixture. Where modified by the term “about”, the claims appended hereto include equivalents to these quantities.

“Optional” or “optionally” means that the subsequently described event or circumstance may but need not occur, and that the description includes instances where the event or circumstance occurs and instances in which it does not. For example, “A optionally B” means that B may but need not be present, and the description includes situations where A includes B and situations where A does not include B.

“Includes” or “including” or like terms means “includes but not limited to.”

As used herein, the recitation in a claim of a claim element in the singular number is to be construed as not to exclude the presence of one or more of the same element.

The compounds of the invention have, in embodiments, one or more isomers. Where an isomer can exist but is not specified, it should be understood that the invention embodies all isomers thereof, including stereoisomers, conformational isomers, and cis, trans isomers; isolated isomers thereof; and mixtures thereof.

The present invention may suitably comprise, consist of, or consist essentially of, any of the disclosed or recited elements. Thus, the invention illustratively disclosed herein can be suitably practiced in the absence of any element which is not specifically disclosed herein.

### Experimental Section

The following Examples further elucidate and describe the SAP and PVGA of the invention and applications thereof without limiting the scope thereof. The graphical representations of the reactions carried out in the Examples are meant to be illustrative of the chemical reactions and processing methods and are not meant to limit the scope of possible products formed thereby.

### A. General Experimental Methods and Information

1. Temperature.

Where “ambient temperature” or “laboratory temperature” is used in conjunction with experimental procedures below, the temperature ranges from about 20° C. to 27° C.

2. Reagents.

All reagents were received from the Sigma Aldrich Company of St. Louis, Mo. and used without further purification unless stated otherwise. Poly(vinyl alcohol) (>98% hydrolyzed) ranged in MW from 146,000 to 186,000, unless stated otherwise. SURINE® synthetic urine was purchased from Dyna-Tek, Inc. of Lenexa, Kans. All “Control” SAP samples (also labeled “C” in tables) were particles extracted directly from PAMPERS® SWADDLERS®, New Baby, pack of 36, Serial No. 9197U0176021145 (obtained from Procter & Gamble of Cincinnati, Ohio). The particles were gathered by cutting the fabric of the bulk dry diapers and pouring the particulates contained inside the fabric into a receptacle. The particles were used without modification.

3. Gel Permeation Chromatography (GPC).

All equipment was obtained from the Waters Corporation of Milford, Mass. A Waters 2695 separations module and a Waters 2414 refractive index detector running at 410 nm are used with a Waters Ultrahydrogel Linear 7.8×300 mm column and a Waters Ultrahydrogel 6×40 mm Guard Column. The mobile phase was aqueous 0.1M sodium nitrate with 0.05% sodium azide. Flow rate was 0.8 mL/min. Poly(ethylene oxide) was used as the calibration standard and was obtained from Polymer Standards Service GmbH (www.polymer.de). M. range was 19,100-671,000 g/mol.

4. Neutralization Procedure.

A sample of 0.2 g of dry particulate material is added to a 20 mL scintillation vial. A 10% aqueous sodium hydroxide solution is added to the vial. The amount of solution is calculated based on a 105% molar equivalent of theoretical free carboxylic acid groups present in the SAP. The calculated volume is added by micropipette to the scintillation vial and the mixture is allowed to stand at ambient temperature for one hour. Then the vial is capped tightly and heated to a temperature of 40°-90° C. for 1-16 hours. The contents of the vial are then transferred to a 50 mL polypropylene centrifuge tube and washed three times with 50 mL portions of deionized water. Excess water is removed using a syringe and the hydrogel is placed in a pre-weighed glass petri dish. Interstitial water is removed by contacting the material with a laboratory wipe. The material is then weighed on an analytical balance to determine hydrogel mass. The dish holding the hydrogel is then transferred to the drying oven and dried to a constant mass.

5. Solubles.

The neutralized and dried material from the Neutralization Procedure is weighed (“dry mass”) and used for further evaluations. The “theoretical dry mass” of a material is calculated based on 100% neutralized material from the Neutralization Procedure. Then percent of soluble material lost in is calculated according to Equation (a).

% Solubles=[(theoretical dry mass−dry mass)/(theoretical dry mass)]×100 (a)

Each determination is conducted in triplicate and the average of the three calculations reported. Where reported, standard deviation for each set of determinations is calculated using Microsoft® Excel® (Microsoft Office 2007 software, available from the Microsoft Corporation of Redmond, Wash.). The amount of solubles is indicative of an overall yield loss in the synthesis of PVGA as a sodium salt.

6. Zero-Load Capacity.

The neutralized and dried material from the Neutralization Procedure is immersed in a test liquid (deionized water, SURINE®, or 0.9 wt % NaCl solution) for 16-18 hours to form a swollen mass. Then any excess liquid is removed by syringe and blotted with a paper towel. The swollen material is weighed immediately after blotting (“swollen material mass”) and capacity determined as given in Equation (b) and is expressed as grams of liquid absorbed per gram of dry material.

Capacity, g/g=(g swollen material mass−g dry mass)/(g dry mass) (b)

Each determination is conducted in triplicate and the average of the three calculations reported. Where reported, standard deviation for each set of determinations is calculated using Microsoft® Excel® (Microsoft Office 2007 software, available from the Microsoft Corporation of Redmond, Wash.).

7. Capacity Under Load.

CARVER® Press test cylinders (part #1520.37, obtained from Carver, Inc. of Wabash, Ind.) were used to test absorbance of various test fluids by the materials of the invention under load. The outer cylinder, base plug, and felt pad of the Carver equipment were assembled to form a test assembly, and the test assembly was placed in a metal pan. The inner plunger of the assembly (radius=1.125 in.; weight=3.619 lb) impinges 0.909 lb/in² (6.27 kPa) onto a swollen material filling the entire perimeter of the outer cylinder.

The material to be tested is swollen in aqueous 0.9% NaCl solution on a laboratory bench for about 16 hours, and the resulting zero-load capacity determined as set forth in the Zero Load Capacity test. Then the swollen material from the Zero Load Capacity test is transferred into the outer cylinder of the test assembly. The inner plunger is inserted into the base cylinder and allowed to rest on top of the swollen material, wherein air between the inner plunger and base cylinder escapes through the gap between them. The inner plunger is allowed to remain on top of the swollen material until liquid is no longer observed flowing into the pan, typically about 5-10 minutes. At this point the inner cylinder is removed and compressed material is recovered from the test assembly and weighed.

The capacity under load is calculated according to Equation (c) and expressed as grams of liquid retained under load per gram of dry material.

Capacity Under Load, g/g=[(g compressed material mass)−(g dry mass)]/(g dry mass) (c)

Each determination is conducted in triplicate and the average of the three calculations reported. Where reported, standard deviation for each set of determinations is calculated using Microsoft® Excel® (Microsoft Office 2007 software, available from the Microsoft Corporation of Redmond, Wash.).

8. Sizing Procedure.

Dry, coarse polymer particles are milled using a Cuisinart Powerblend 600 Blender. The resulting dry particles are poured into a stack of sieves, ordered from coarsest to finest, and the sieves are agitated by hand to separate the particles. The sieves are U.S.A. Standard Test Sieve ASTM E-11 Specification, obtained from Fisher Scientific of Waltham, Mass. Each sieve has a specific particle size cutoff. The specific sizes used in these experiments are 1.4 mm, 850 μm, 425 μm, 300 μm, and 150 μm. Then the desired fraction is used immediately, or stored in a sealed plastic sample bag until further processing or testing is carried out.

### B. Examples

### Example 1

To a 1 L roundbottom flask was added 250 ml of 5% wt aqueous solution of PVOH (99% hydrolyzed, M_{w} 188,000) and 28 ml of 50 wt % aqueous solution of glyoxylic acid. The flask contents were mixed thoroughly using a mechanical stirrer. Then 4 grams of sodium hydroxide dissolved in 100 ml of water was added to the flask with mechanical stirring. The resulting mixture was mounted on a rotary evaporator and the flask partly submersed in an oil bath set to 60° C.; pressure was reduced to 15-25 Torr and the flask was rotated in the oil bath. Water was observed to collect in the catch flask of the rotary evaporator. After evaporation of water had subsided, the flask contained a semi-transparent, rubbery material. The material recovered from the bottom of the flask weighed 25.2 g. The polymer had a glass transition of 0° C., capacity of 37 g DI H₂O/g, and an initial rate of water absorption of approximately 0.06 g of DI H₂O/g per second (0.06 g/g·sec). When the material was heated to 100° C. for 15 min, the capacity with respect to DI H₂O was diminished by approximately an order of magnitude.

### Example 2

A reaction was carried out according to Example 1, except that no sodium hydroxide was added. The resulting polymer had a water absorption capacity of 6 g DI H₂O/g.

### Example 3

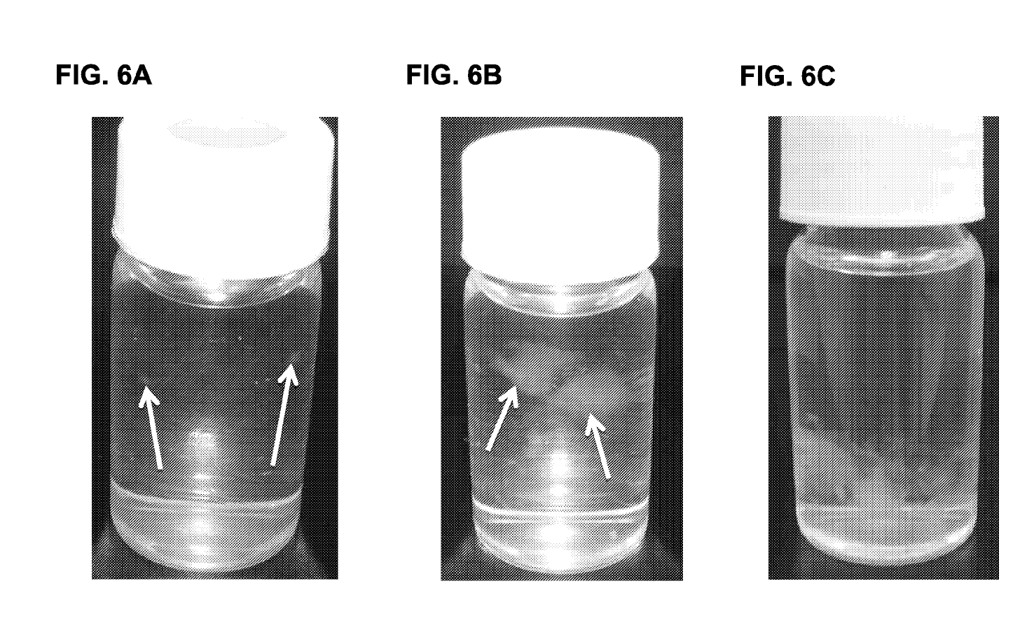

Approximately 0.5 g of the material obtained in Example 1 was dispersed in 20 mL of deionized water in a vial. The vial was capped and allowed to sit at ambient temperature on a laboratory benchtop. After about 1 week, two patches of a white/gray, moldy appearing material were observed to be suspended in or on the hydrogel. A photograph of the vial was taken and this photograph is shown in FIG. 6A; the arrows indicate the moldy appearing material. The vial was allowed to remain on the benchtop for an additional 4 weeks, during which time the moldy material was observed to grow into large patches. A second picture of the vial was taken and this photograph is shown in FIG. 6B; the arrows indicate the moldy appearing material. The vial was allowed to remain on the benchtop for an additional 3 weeks, during which time the moldy material was observed to grow; at the end of the 3 weeks the gel had disappeared completely and the gray material had fallen to the bottom of the vial. The contents of the vial were no longer a gel, but flowed like a slightly viscous liquid. A third picture of the vial was taken and this photograph is shown in FIG. 6C.

### Example 4

About 1 g of the dried material obtained in Example 1 is added to a vial and allowed to sit in the vial without a cap on a laboratory bench at ambient temperature. After 6 months, the appearance of the polymer is unchanged. The polymer has a glass transition of 0° C., water absorbing capacity of 37 g of water per 1 g of polymer (37 g/g), and an initial rate of water absorption of approximately 0.06 g of water per g polymer per second (0.06 g/g sec⁻¹).

### Example 5

A reaction is carried out according to Example 1 except that (a) PVOH has Mw of 500,000, (b) 0.5 ml of 40 wt % aqueous solution of glyoxal is added to the reaction mixture before addition of sodium hydroxide, (c) the amount of sodium hydroxide was increased to 7.1 g. The polymer resulting polymer has a water absorbing capacity of approximately 100 g/g of polymer, and an initial rate of water absorption of approximately 0.15 g of water per g polymer per second.

### Example 6

A reaction is carried out according to Example 2, except that 0.1 g of furfural is added to the reaction mixture in addition to glyoxylic acid. After reducing volume of reaction mixture on the rotary evaporator to approximately 60 ml, the content of the flask is spread on a teflon-lined pan to form a gelatinous mass of about 0.5 cm thickess. A UV-A lamp having wavelength intensity of 225 mW/cm² in the range 320-390 nm is used to irradiate the contents of the pan.

The polymer is then removed from the pan and dried in a vacuum oven at 50 C, 15 Torr for 10 hours. The dried polymer has water absorbing capacity of approximately 100 g/g and a rate of water absorption of approximately 0.2 g/g sec⁻¹.

### Example 7

A reaction is carried out according to Example 1, except that 1 g of sodium dodecyl sulfate is added to the reaction mixture and pressure is not reduced when employing the rotary evaporator. The resulting polymer has the same absorption capacity of the polymer of Example 1, but the rate of absorption is 0.12 g of water per g polymer per second.

### Example 8

Glyoxylic acid (GA) was subjected to biodegradation employing the following materials and procedures.

Materials:
1. Source of microbial diversity: sludge from St. Paul, Minn., Municipal Wastewater Treatment Facility
2. Growth medium—M9 minimal salt medium:
   a. Components for 1 L (5×) M9 salts: Na₂HPO₄ 33.9 g/L; KH₂PO₄ 15 g/L; NaCl 2.5 g/L; NH₄Cl 5 g/L.
   b. Preparation:
      i. Dissolve 56.4 g in 1 L of distilled water.
      ii. Autoclave for 20 minutes at 121° C. 5× concentrate can be stored and diluted as needed to prepare 1×M9 minimal salts.
      iii. Aseptically dilute 200 mL of M9 minimal salts, 5× concentrate with ˜790 mL of sterile water.
      iv. Aseptically add 2 mL of sterile 1M magnesium sulfate and 0.1 mL of 1M sterile calcium chloride to prepare 1 L of M9 minimal medium.
      v. Aseptically add ˜8 g/L desired carbon source to working volume of M9.
   c. Carbon Source:
      i. 50 wt % glyoxylic acid solution purchased from Sigma-Aldrich was diluted and titrated with NaOH to obtain 8 wt % GA (10×) stock solution with pH 7.
      ii. Negative Control: no carbon.

Experimental Scheme (“T” Means Transfer):
1. T₀ (initial inoculum)—5 ml sludge to 20 ml M9—3 days incubation at 25-27° C. with shaking at 180 rpm
2. T₁—5 ml T₀ to 20 ml fresh M9—3 days incubation at 25-27° C. with shaking at 180 rpm
3. T₂—5 ml T₁ to 20 ml fresh M9—3 days incubation at 25-27° C. with shaking at 180 rpm
4. T₃—5 ml T₂ to 20 ml fresh M9—1-3 day incubation at 25-27° C. with shaking at 180 rpm
5. T₄—5 ml T₃ to 20 ml fresh M9—1-3 day incubation at 25-27° C. with shaking at 180 rpm
6. T₄—0.1 ml plated on solid M9 plates containing 15 g/l agar and 8 g/L GA as sole carbon source.
7. T₅—cells scrubbed from the plate using microbiological loop were transferred (i) to liquid medium for growth curve experiment where microbial growth is measured by increase in turbidity at OD₆₀₀, and (ii) to fresh solid M9 plates containing 15 g/l agar and 8 g/LGA as a sole carbon source for observing growth of individual colonies.

Municipal sludge is the source of many thousands of species of microorganisms that are subjected to variable sources of environmental pressure and exposure to various chemical entities. They can utilize various organic chemicals as a carbon source. T₀ flasks inoculated with 5 ml municipal sludge initially look dark-grey. The flasks change color to brownish after 3 days incubation indicating initial growth. The starting sludge typically contains some nutrients and at this stage observed microbial growth could be attributed to sludge nutrients. After 2-3 consecutive transfers all initial sludge nutrients are depleted and microbial growth could be possible only due to utilization of the supplemented carbon source.

T₁ flasks containing 20 ml fresh M9 medium were inoculated with 5 ml 3-day old T₀ cultures. A 1:5 dilution was chosen for keeping enough microbial diversity after the culture transfer. After 3 days growth at 25-27° C. with 180 rpm shaking the T₁ cultures were transferred again using the same 1:5 dilution, they become T₂ cultures. The negative control cultures that contained M9 without carbon source at this stage looked clear and had no indication of microbial growth. New transfers to fresh M9 medium supplemented with GA were performed every 1-3 days using 1:5 dilution and freshly inoculated cultures are designated T₃, T₄, T₅, etc.

In addition to testing microbial growth in liquid medium, 0.1 ml of T₃ culture was transferred and evenly dispersed on M9 agar plates containing 15 g/L agar and 8 g/L GA. The plates were incubated at 25-27° C. Within next 3 days no growth was observed on plates without carbon. However, in the presence of 8 g/L GA as a carbon source a number of individual colonies grew on the plate.

For demonstrating consistent growth on solid minimal medium, a loop of cells was taken from the T₄ plate containing 8 g/L GA as a sole carbon source and transferred on fresh M9 plate (T₅) supplemented with the same GA concentration.

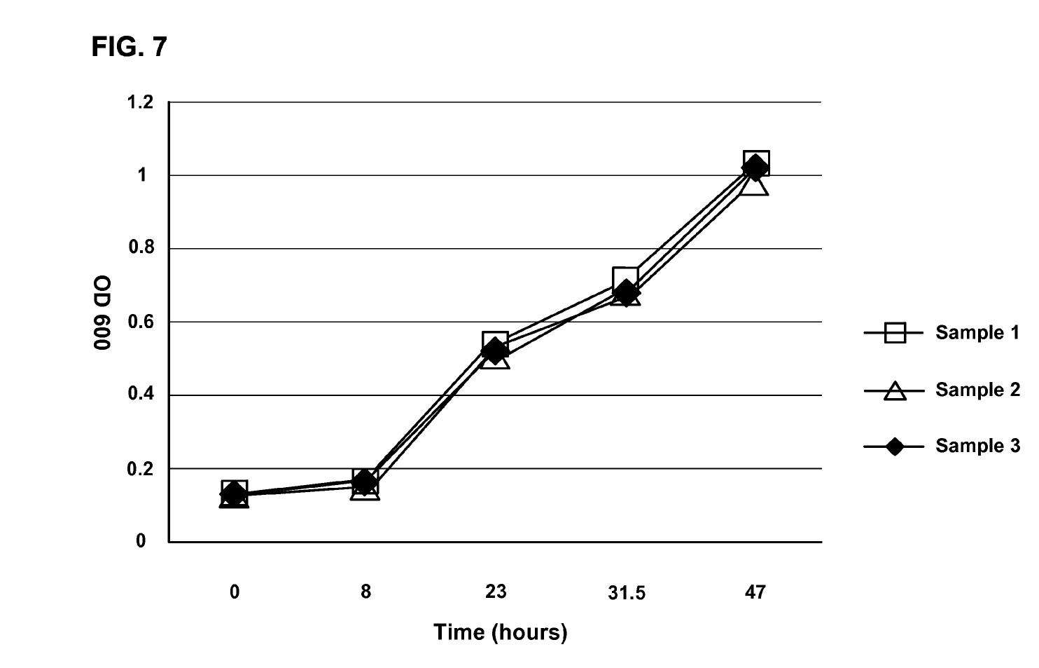

For a growth curve study a loop full of cells taken from T₅ M9 plate supplemented with 8 g/L GA was suspended in fresh liquid M9 medium and diluted to OD₆₀₀ ˜0.1. Equal 2 ml aliquots of the cell suspension were transferred to 13 mm glass tubes for growth experiment. Alternatively, T₅ liquid culture was diluted to OD₆₀₀ ˜0.1. Equal 2 ml aliquots of the cell suspension were transferred to 13 mm glass tubes for growth experiment. The experiments were conducted in triplicate at 25-27° C. with 180 rpm shaking. The change in optical density (OD) was followed using a Genesys 6 Spectrophotometer (available from Thermo Fisher Scientific of Waltham, Mass.) at 600 nm for 48 hours. The increase in optical density demonstrated growth of microbial culture on GA as a sole carbon source, as shown in FIG. 7 for the triplicate samples. Furthermore, when cell culture growth reached OD₆₀₀ equal 1, the pH of the growth medium increased from 7 to ˜9 also indicating utilization of GA. Both methods for determining the growth curve produced similar results.

### Example 9

A 2 L roundbottom flask equipped with mechanical stirrer was charged with 500 ml of deionized water and 100 g PVOH (99%+hydrolyzed, M_{w} 140,000-188,000). The contents of the flask were heated to 90° C. and stirred for about 3 hours until the mixture appeared homogeneous. The mixture was allowed to cool to about 80° C., and 118.5 g of 50 wt % aqueous solution of glyoxylic acid was introduced over a period of about 5 minutes. The flask contents were mixed thoroughly using a mechanical stirrer for about 30 minutes until a gel was observed to form. The stirring was stopped and the gel was allowed to stand at 80° C. for about 60 minutes. The gel was fragmented by cutting into pieces weighing about 5-10 g each and retrieved from the flask. The gel was then ground using a Waring Pro MG100 meat grinder (from Waring Consumer Products, East Windsor, N.J.) equipped with a fine cutting plate (3 mm holes). The resulting ground gel was then placed in PTFE-coated pans and dried in a vacuum oven at 105° C., 20 Torr for 4 hours until hard solid lumps were formed. The solid lumps were milled in a Cuisinart PowerBlend 600 blender (from Cuisinart, East Windsor, N.J.), to give a free-flowing solid with broad particle size distribution (about 0.1-1 mm). These solids were used in the subsequent examples below.

### Example 10-14

A series of 500 mg portions of solids prepared according to Example 9 were placed in 15 ml conical bottom vials, and varying pre-measured amounts of 10 wt % solution of sodium hydroxide in water were added to each vial (ranging from 1.36 to 1.6 g of NaOH solution per sample). Optionally, additional water was introduced in some of the samples. The vials were then capped and placed in an oven at 70° C. for 16 hours. Then the vials were removed from the oven and 100 ml of deionized water was added to each of the vials. Upon addition of water to the vials, rapid swelling was observed. The contents of the vials were individually washed 4 times with 50 mL of deionized water until pH of the excess wash water was nearly neutral (pH 5-6). The washed hydrogels were then dried in a convection oven at 110° C. for about 4 hours to yield pale yellow solid particles.

Aliquots of the solids were weighed and the capacity was determined with respect to deionized water. For the purpose of this set of Examples, absorbing capacity was determined by placing a weighed amount of the solid particles in a flask and adding sufficient deionized water such that excess liquid water remained in the flask after about 12 hours at ambient temperature. Then the hydrogel that formed was removed from the flask, excess water was blotted, and the hydrogel was weighed. The results are summarized in Table 2, wherein capacity is reported in grams of water absorbed per gram of dry particles.

TABLE 2
Water absorption measurements for PVGA particles.

| | g 10% NaOH added | Additional | Capacity |
|---|---|---|---|
| Example | per 500 mg PVGA | water added, g | (g DI H₂O/g) |
| 10 | 1.36 | 0 | 86 |
| 11 | 1.46 | 0 | 100 |
| 12 | 1.47 | 1.5 | 112 |
| 13 | 1.47 | 3.0 | 96 |
| 14 | 1.6 | 0 | 191 |

### Example 15

The absorbing capacity of the washed and dried polymer obtained in the Example 14 was measured using the technique employed for measuring absorbing capacity in Examples 10-14, except that 0.9 wt % NaCl in water was used instead of deionized water. The absorbing capacity of the dried washed polymer of Example 14 was determined to be 35 g of 0.9 wt % sodium chloride solution per gram of dried washed polymer.

### Example 16

To a 1000 mL PYREX® beaker was added 75.1 g PVOH and 380.2 g deionized water. The beaker was placed in a sand bath and equipped with an overhead mechanical stirrer and internal temperature probe. The top of the beaker was covered in aluminum foil and the contents of the beaker were heated with stirring to 90° C. over two hours. A solution of 38.2 g glyoxylic acid and 2.08 μL conc. sulfuric acid (obtained from Acros Organics of Geel, Belgium) was added portionwise to the mixture over one minute. Stirring was continued for about 10 minutes. At this point the viscosity of the mixture had increased markedly and stirring was no longer effective. The mixture was cooled and allowed to stand at ambient temperature over about 16 hours. A gel was recovered, which was broken into pieces and dried in a drying oven at 105° C. for 8 hours. The dried mixture was ground in a blender and the resulting particles were sized between about 850 μm and 1.4 mm according to the Sizing Procedure.

The particles were neutralized and washed according to the Neutralization Procedure. The % solubles and absorption capacity to deionized water, 0.9 wt % NaCl in deionized water, and SURINE® synthetic urine was determined as shown in Table 3.

### Example 17

After grinding the dried mixture from Example 16, a second sample sized between 150 μm and 850 μm was collected according to the Sizing Procedure. The particles were neutralized and washed according to the Neutralization Procedure.

### Example 18

To a 500 mL PYREX® beaker was added 38.1 g PVOH (0.83 mol theoretical vinyl alcohol repeat units, Sigma Aldrich Lot # MKBD5520) and 192 g of deionized water. The beaker was placed in a sand bath and equipped with an overhead mechanical stirrer and internal temperature probe. The top of the beaker was covered in aluminum foil and the contents were heated with stirring to 90° C. over about one hour. A solution of 19.05 g glyoxylic acid and 3.15 g sodium hydroxide (obtained from Fisher Scientific of Waltham, Mass.) diluted in 50 mL deionized water was added portionwise to the mixture over about one minute. Stirring was then continued for about 30 minutes. At this point the viscosity of the mixture had increased markedly and stirring was no longer effective. The mixture was transferred to a Teflon-coated pan and dried in a drying oven at 70° C. for 13 hours. The dried mixture was ground in a blender and the resulting particles were sized between 850 μm and 1.4 mm as determined by the Sizing Procedure.

A 0.2 g sample of the particles were neutralized and washed according to the Neutralization Procedure. The % solubles and absorption capacity to deionized water, 0.9 wt % NaCl in deionized water, and SURINE® synthetic urine was determined as shown in Table 3.

### Example 19

A polymer was made and formed into particles according to the procedure of Example 18, except that the particles were sized between 300 and 450 μm according to the Sizing Procedure and neutralization was carried out using about 30 g of particles.

SEM photographs were taken of a representative particle. FIG. 1 shows a particle at 100×. FIG. 2 shows the particle at 1000×. Mercury porosimetry was carried out on a representative sample of particles. The amount of mercury intrusion was minimal thus having insufficient surface area for this method to produce reliable reading. B.E.T. surface area analysis was also conducted for this sample, and the surface area was determined to be too low for the method range.

### Example 20

A polymer was made and formed into particles according to the procedure of Example 19. Then 2.0 g of the particles were swollen in 100 mL of deionized water, and the excess water was decanted. The swollen particles were washed twice with 100 mL ethanol, wherein after each wash excess liquid was decanted. The resulting particles were dried in a drying oven at 70° C. to a constant weight.

SEM photographs were taken of a representative particle. FIG. 3 shows a particle at 100×. FIG. 4 shows a portion of the particle surface at 1000×. FIG. 5 shows a portion of the particle surface at 75,000×. Mercury porosimetry was carried out on a representative sample of particles, using the same procedure as for Example 19. The particles were found to have an average measured surface area of 54.1 m²/g. B.E.T. surface area analysis was also conducted for this sample, and surface area was determined to be 20.01 m²/g±0.44 m²/g.

### Example 21

To a 1000 mL PYREX® beaker was added 75.1 g PVOH and 407 g deionized water. The beaker was placed in a sand bath and equipped with an overhead mechanical stirrer and internal temperature probe. The top of the beaker was covered in aluminum foil and the contents of the beaker heated with stirring to 90° C. over about one hour. A solution of 38.1 g glyoxylic acid and 6.0 g sodium hydroxide in 100 mL deionized water was added portionwise to the beaker over about 2 minutes. Stirring was continued for about two hours. At this point, stirring was discontinued and the mixture was allowed to stand at approximately 60° C. for about 16 hours. Then the contents of the beaker were transferred to a Teflon-coated pan and dried in a drying oven at 70-80° C. for 4 hours, then 100° C. for 8 hours. The dried mixture was ground in a blender and the resulting particles were sized between 850 μm and 1.4 mm according to the Sizing Procedure.

The particles were neutralized according to the Neutralization Procedure. The % solubles and absorption capacity to deionized water and 0.9 wt % NaCl in deionized water was determined as shown in Table 3.

### Example 22

To a 500 mL PYREX® beaker was added 37.5 g PVOH and 192 g of deionized water. The beaker was placed in a sand bath and equipped with an overhead mechanical stirrer and internal temperature probe. The top of the beaker was covered in aluminum foil and the contents of the beaker were heated with stirring to 90° C. over about one hour. A solution of 19.1 g glyoxylic acid, 1.83 g glyoxal, and 3.08 g sodium hydroxide diluted in 100 mL deionized water was added portionwise to the beaker over about 2 minutes. Stirring was continued for about 30 minutes. At this point the viscosity of the mixture had increased markedly and stirring was no longer effective. The mixture was transferred to a Teflon-coated pan and dried in a drying oven at 70-80° C. for about 12 hours. The dried polymer was ground in a blender and the resulting particles were sized between 850 μm and 1.4 mm according to the Sizing Procedure.

The particles were neutralized and washed according to the Neutralization Procedure. The % solubles and absorption capacity to deionized water and 0.9 wt % NaCl in deionized water was determined as shown in Table 3.

### Example 23

To a 600 mL PYREX® beaker was added 37.7 g PVOH (Sigma Aldrich, Lot #10708CHV MW=130,000) and 193 g deionized water. The beaker was placed in a sand bath and equipped with an overhead mechanical stirrer and internal temperature probe. The top of the beaker was covered in aluminum foil and the contents of the beaker heated with stirring to 90° C. over one hour. Then 19.05 g glyoxylic acid was added portionwise to the beaker over about one minute. Stirring was continued for about 10 minutes. At this point the viscosity of the mixture had increased markedly and stirring was no longer effective. The mixture was cooled and allowed to stand at ambient temperature over about 16 hours. The recovered mixture was dried in a drying oven at 60° C. for about 7 hours, then at 100° C. for about 4 hours. The dried mixture was ground in a blender and the resulting particles were sized between 805 lam and 1.4 mm according to the Sizing Procedure.

The particles were neutralized and washed according to the Neutralization Procedure. The % solubles and absorption capacity to deionized water and 0.9 wt % NaCl in deionized water was determined as shown in Table 3.

### Example 24

To a 600 mL PYREX® beaker was added 37.5 g PVOH (Sigma Aldrich, Batch# MKBD2262V MW=89-98,000) and 196 g of deionized water. The beaker was placed in a sand bath and equipped with an overhead mechanical stirrer and internal temperature probe. The top of the beaker was covered in aluminum foil and the contents of the beaker were heated with stirring to 90° C. over about 1.5 hours. Then 19.05 g glyoxylic acid was added portionwise to the beaker over about one minute. Stirring was continued for about 30 minutes. At this point the viscosity of the mixture had increased markedly and stirring was no longer effective. The mixture was cooled and allowed to stand at ambient temperature over 2 days. The mixture was recovered from the beaker and dried in a drying oven at 80° C. for about 13 hours. The dried mixture was ground in a blender and the resulting particles were sized between 850 μm and 1.4 mm according to the Sizing Procedure.

The particles were neutralized and washed according to the Neutralization Procedure. The % solubles and absorption capacity to deionized water and 0.9 wt % NaCl in deionized water was determined as shown in Table 3.

### Example 25

To a 1000 mL PYREX® beaker was added 75.0 g PVOH and 379.9 g of deionized water. The beaker was placed in a sand bath and equipped with an overhead mechanical stirrer and internal temperature probe. The top of the beaker was covered in aluminum foil and the contents of the beaker heated with stirring to 90° C. over about two hours. Then a solution of 44.4 g glyoxylic acid (44.4 g, 0.60 mol, Aldrich) and 2.4 μL sulfuric acid (obtained from Acros Organics of Geel, Belgium) was added portionwise to the beaker over about one minute. Stirring was continued for about 5 minutes. At this point the viscosity of the mixture had increased markedly and stirring was no longer effective. The mixture was cooled and allowed to dry in a laboratory hood for about 16 hours. The recovered mixture was broken into pieces and dried in a drying oven at 105° C. for 8 hours. The dried polymer was ground in a blender and particles were sized between 850 μm and 1.4 mm as determined by the Sizing Procedure.

The particles were neutralized and washed according to the Neutralization Procedure. The % solubles and absorption capacity to deionized water, 0.9 wt % NaCl in deionized water, and SURINE® synthetic urine was determined as shown in Table 3.

### Example 26

To a 1000 mL PYREX® beaker was added 75.0 g PVOH and 383.5 g of deionized water. The beaker was placed in a sand bath and equipped with an overhead mechanical stirrer and internal temperature probe. The top of the beaker was covered in aluminum foil and the contents of the beaker were heated with stirring to 90° C. over about 1.5 hours. A solution of 44.4 g glyoxylic acid (44.4 g, 0.60 mol, Aldrich), 2.4 μL conc. sulfuric acid (obtained from Acros Organics of Geel, Belgium), and 0.879 mL of a 40 wt % solution of glyoxal was added portionwise to the mixture over about one minute. Stirring was continued until the viscosity of the mixture had increased markedly and stirring was no longer effective. The mixture was cooled and allowed to stand at ambient temperature for about 16 hours. The recovered mixture was broken into pieces and dried in a drying oven at 100° C. for about 6 hours. The dried mixture was ground in a blender and particles were sized between 805 μm and 1.4 mm as determined by the Sizing Procedure.

The particles were neutralized and washed according to the Neutralization Procedure. The % solubles and absorption capacity to deionized water, 0.9 wt % NaCl in deionized water, and SURINE® synthetic urine was determined as shown in Table 3.

### Example 27

To a 600 mL PYREX® beaker was added 37.5 g PVOH and 195 g deionized water. The beaker was placed in a sand bath and equipped with an overhead mechanical stirrer and internal temperature probe. The top of the beaker was covered in aluminum foil and the contents of the beaker were heated with stirring to 90° C. over about one hour. Then 38.1 g of a 50% solution of glyoxylic acid in water (obtained from the Aceto Corporation of Port Washington, N.Y.) was added portionwise to the mixture over about 2 minutes. Stirring was continued for about 10 minutes. At this point the viscosity of the mixture had increased markedly and stirring was no longer effective. The mixture was allowed to stand overnight at about 60° C., then the heat was shut off and the contents of the beaker allowed to cool to laboratory temperature. A gel was recovered, which was broken into pieces and dried in a drying oven at 70° C. for about 3 hour, then 90° C. for about 6 hours.

The dried mixture was ground in a blender and the resulting particles were sized between about 850 μm and 1.4 mm according to the Sizing Procedure. The particles were neutralized and washed according to the Neutralization Procedure. The % solubles and absorption capacity to deionized water and 0.9 wt % NaCl solution was determined according to the procedures outlined above, and the results are shown in Table 3.

TABLE 3
Capacity of washed PVGA and % soluble material of PVGA
of the invention compared to Pampers ® control (C),
for various test liquids.

| | | | | Capacity, g |
|---|---|---|---|---|
| Example | | Capacity, | Capacity, g 0.9% | SURINE ®/ |
| No. | % Solubles | g DI H₂O/g | NaCl solution/g | g |
| 16 | 25.4 ± 1.5 | 64.6 ± 6.7 | 22.8 ± 1.2 | 17.5 ± 0.6 |
| 18 | 47.8 ± 3.3 | 159.6 ± 24.5 | 40.8 ± 3.8 | 27.2 ± 0.9 |
| 21 | 49.6 ± 5.9 | 238.6 ± 31.6 | 46.3 ± 4.6 | N/A |
| 22 | 42.9 ± 4.7 | 55.5 ± 2.3 | 15.2 ± 0.9 | N/A |
| 23 | 21.5 ± 0.9 | 74.0 ± 1.5 | 22.6 ± 0.4 | N/A |
| 24 | 41.3 ± 0.8 | 138.8 ± 5.6 | 30.7 ± 0.9 | N/A |
| 25 | 29.4 ± 0.6 | 76.7 ± 1.0 | 29.7 ± 3.7 | 22.6 ± 0.5 |
| 26 | 30.3 ± 2.2 | 81.0 ± 12.1 | 28.5 ± 3.1 | 29.2 ± 3.5 |
| 27 | 25.7 ± 1.0 | 64.0 ± 2.5 | 22.8 ± 0.7 | N/A |
| C | N/A | 299 ± 20 | 30.1 ± 0.7 | 26.0 ± 0.8 |

### Example 28

To a 1000 mL PYREX® beaker was added 75.2 g PVOH (Sigma Aldrich, Lot #MKBC6795V, MW=13,000-23,000) and 382 g of deionized water. The beaker was placed in a sand bath and equipped with an overhead mechanical stirrer and internal temperature probe. The top of the beaker was covered in aluminum foil and the contents of the beaker heated with stirring to 90° C. over about 40 minutes. Then 38.1 g glyoxylic acid was added portionwise to the beaker over about two minutes. Stirring was continued for about 45 minutes while the mixture cooled to 60° C. The mixture was allowed to stand at 60° C. for about 16 hours. The mixture was observed to remain fluid; it was poured into a Teflon coated pan and dried in a drying oven at 90° C. for about 8 hours. The dried mixture was ground in a blender and the resulting particles were sized between 850 μm and 1.4 mm according to the Sizing Procedure.

Then 30.0 g of the particles were added to a 500 mL glass bottle, followed by 50 mL of deionized water, and 68.4 mL of 10% NaOH in water. The bottle was loosely capped and the contents heated to 80-90° C. for about 4 hours. The contents of the bottle were transferred to a 2 L glass bottle and diluted in 1800 mL of deionized water. Then the diluted contents were dialyzed three times against deionized water using dialysis tubing having a lower MW cutoff of 10,000. The dialyzed contents were gravity filtered one time through nylon mesh and a second time through laboratory wipe plug placed in a funnel The filtered contents were concentrated under vacuum using a rotary evaporator to yield 430.1 g of a mixture containing 3.9 wt % solids. The percent solids was determined by weighing an aliquot of the concentrate on an aluminum foil sheet and placing the sheet in a drying oven set to 105°-110° C. until it reached a constant weight.

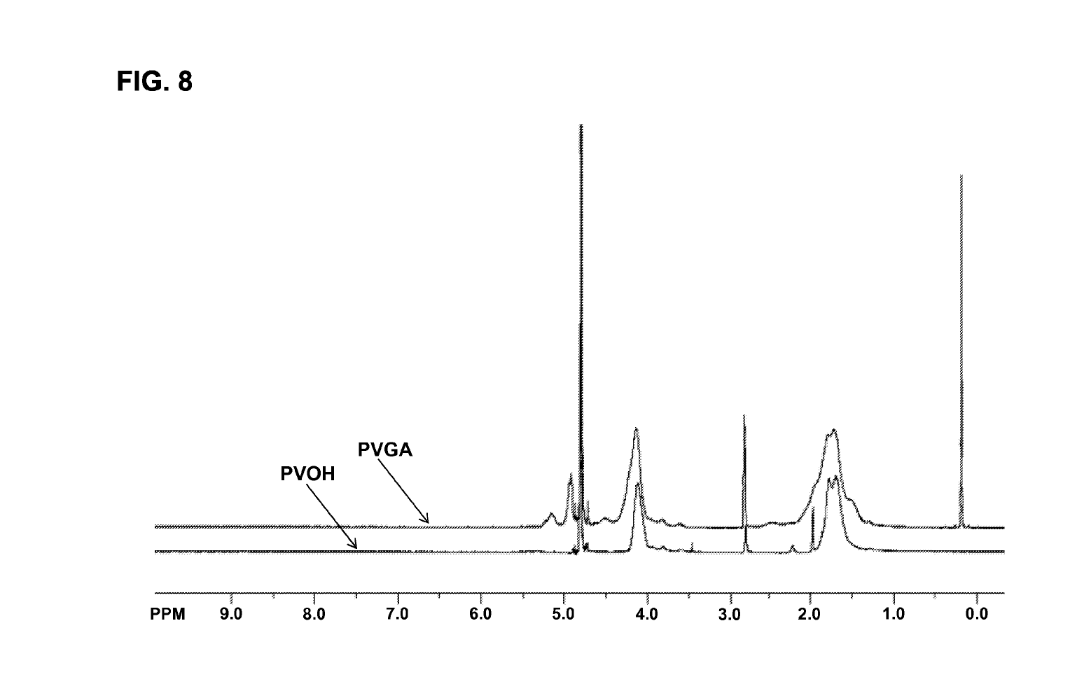

The dried product was analyzed by 1H NMR in 1:1 D2O:d6 DMSO. The PVOH starting material was also analyzed using the same solvent blend. The two spectra are shown in FIG. 8, where the PVOH starting material is labeled “PVOH” and the dried product is labeled “PVGA”. Notably, in the spectrum labeled “PVGA”, no absorbances attributable to aldehyde groups are observed, but absorbances attributable to acetal groups are present.

### Example 29

To a 1000 mL PYREX® beaker was added 75.1 g PVOH and 382 g of deionized water. The beaker was placed in a sand bath and equipped with an overhead mechanical stirrer and internal temperature probe. The top of the beaker was covered in aluminum foil and the contents of the beaker heated with stirring to 90° C. over about two hours. A solution of 44.4 g glyoxylic acid, 2.4 μL conc. sulfuric acid (obtained from Acros Organics of Geel, Belgium), and 0.175 g glyoxal was mixed and this was added portionwise to the mixture over about one minute. The temperature of the mixture inside the beaker was observed to be about 80° C. after the addition was complete. Stirring was continued for about 15 minute, at which point the mixture became too viscous to stir. The mixture was allowed to stand at ambient temperature overnight, then the mixture was recovered from the beaker and broken into pieces manually. The pieces were dried in a drying oven at 105° C. for 5 hours. The dried mixture was ground in a blender and the resulting particles were sized between 850 μm and 1.4 mm according to the Sizing Procedure. The fraction of particles collected in this size range weighed 19.3 grams.

The particles were neutralized and washed according to the Neutralization Procedure.

### Example 30

The materials of Examples 16, 18, and 29 were subjected to the Capacity Under Load test as outlined above. As a Control (C), particles from PAMPERS® were gathered as described above and subjected to the same test. The results are reported in Table 4.

TABLE 4
Zero-load capacity and capacity under load for 0.9 wt % NaCl
solution, for PAMPERS ® (C) and PVGA of the invention.

| | | Capacity, | Capacity under |
|---|---|---|---|
| Example | Dry | g 0.9% aq | load, g 0.9% aq |
| No. | mass, g | NaCl/g | NaCl/g |
| C | 1.06 | 30.1 | 25.3 |
| 18 | 0.51 | 28.4 | 24.1 |
| 29 | 1.26 | 22.7 | 20.8 |
| 17 | 1.40 | 22.8 | 15.1 |

### Example 31

Five emptied nylon mesh tea bags were tared and about 0.1 g to 0.2 g of a material to be tested was added to each bag. The top of each bag was folded over and secured with a paper clip. The five bags were then simultaneously immersed into a beaker containing about 1 L of aqueous 0.9% NaCl solution. Upon immersion a timer was started. The beaker was covered with aluminum foil and bags were withdrawn periodically, and the total immersed time was recorded from the timer. Upon removal from the beaker, each bag was blotted dry with paper towels and weighed.

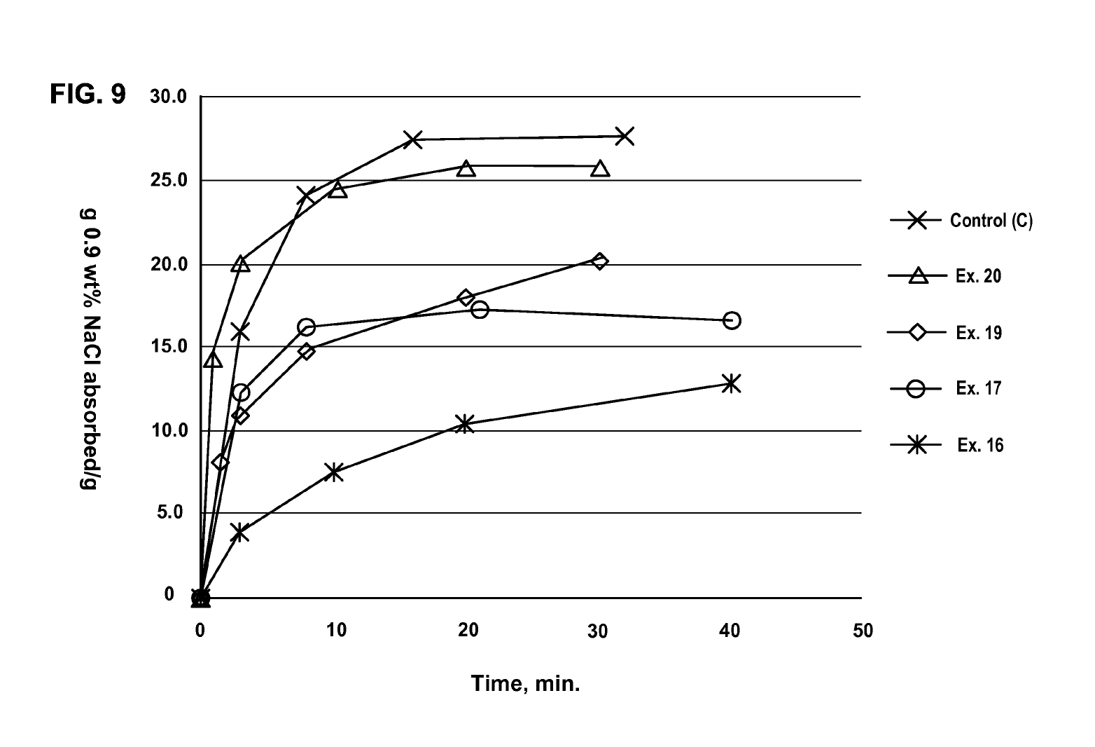

Using the calculation of Equation (b) of the Zero-load Capacity test, the weight in grams of NaCl solution absorbed per gram of material in the mesh bags is reported in Table 5. A plot of 0.9% NaCl absorbed vs. time for all the materials tested is shown in FIG. 9. Using the data from Table 5, the initial rate of absorption and time to reach one-half maximum capacity were determined and these values are shown in Table 6. The time to reach one-half maximum capacity estimate is based on interpolation between two selected data points from Table 5.

TABLE 5
Weight in grams of 0.9 wt % aq NaCl solution absorbed as a
function of time for PVGA of the invention and PAMPERS ®
control material (C).

| Example # - | | Time, | 0.9% aq NaCl |
|---|---|---|---|
| Bag # | Dry Mass, g | min | absorbed, g/g |
| C-1 | 0.1558 | 3.0 | 14.8928 |
| C-2 | 0.2044 | 8.0 | 23.1267 |
| C-3 | 0.2693 | 16.0 | 26.4653 |
| C-4 | 0.2484 | 32.0 | 26.6075 |
| C-5 | 0.1961 | 66.0 | 31.7119 |
| 16-1 | 0.2065 | 3.0 | 3.0426 |
| 16-2 | 0.2190 | 10.0 | 6.6178 |
| 16-3 | 0.2061 | 20.0 | 9.5779 |
| 16-4 | 0.2518 | 40.0 | 11.8312 |
| 16-5 | 0.2208 | 80.0 | 13.5344 |
| 17-1 | 0.1657 | 3.0 | 11.2909 |
| 17-2 | 0.2373 | 8.0 | 15.1622 |
| 17-3 | 0.2194 | 21.0 | 16.2024 |
| 17-4 | 0.1809 | 40.0 | 15.5484 |
| 17-5 | 0.1962 | 50.0 | 16.4924 |
| 19-1 | 0.1111 | 1.5 | 7.1269 |
| 19-2 | 0.1976 | 3.0 | 9.9155 |
| 19-3 | 0.2012 | 8.0 | 13.7749 |
| 19-4 | 0.2689 | 20.0 | 16.9881 |
| 19-5 | 0.1518 | 30.0 | 19.1765 |
| 20-1 | 0.0890 | 1.0 | 13.42 |
| 20-2 | 0.0878 | 3.0 | 19.14 |
| 20-3 | 0.1028 | 10.3 | 23.58 |
| 20-4 | 0.0814 | 20.0 | 24.80 |
| 20-5 | 0.1087 | 30.0 | 24.78 |

TABLE 6
Absorption rate of 0.9 wt % aq NaCl solution by PVGA of the
invention and PAMPERS ® control material (C).

| Example | Initial Rate | |
|---|---|---|
| No. | g/g · min | t_{1/2} (min) |
| C | 5.3 | 4 |
| 16 | 1.4 | 15 |
| 17 | 4.1 | 9 |
| 19 | 5.4 | 2.5 |
| 20 | 14.4 | 0.8 |

### Example 32

A polymer was made according to the procedure of Example 16, except that no gel was recovered; that is, the reaction mixture was employed as follows prior to gel formation, isolation, drying, and addition of sodium hydroxide. FISHERBRAND® Filter Paper, Qualitative P2, Fine Porosity, Slow Flow Rate filter paper (obtained from Fisher Scientific of Waltham, Mass.) was cut into 6 rectangular pieces having dimensions of about 58×27 mm, and each piece was tared. All of the pieces were dipped into the reaction mixture before the mixture reached sufficient viscosity such that dip coating could not be carried out. The paper pieces were each dipped in the reaction mixture at reaction mixture temperature of about 80° C. The dip coated paper was placed in a metal container, covered with aluminum foil, and placed in a drying oven at 70° C. for about 5 hours. Then the aluminum foil was removed and the samples dried at 70° C. for an additional 5 hours. Upon cooling, a hard, transparent film was observed to be strongly adhered to the paper. Then the coated filter papers were immersed and soaked in an aqueous 5% sodium hydroxide solution for 45 minutes. The coated papers were blotted with paper towels to remove excess sodium hydroxide solution and placed in a Teflon-coated metal pan. The pan was covered with aluminum foil and placed in the oven at 90° C. for about 45 minutes. Then the coated papers were washed twice with deionized water, whereupon a marked swelling of the coating was observed. Then the coated papers were dried in a drying oven at 80° C. for about 5 hours.

In all cases, calculations were carried out using an average of the 6 samples tested. Using the measured dry mass of the coatings and the corresponding theoretical weight of the coatings when fully neutralized to the sodium salt, the % solubles were calculated to be 38.1 according to Equation (a). The capacity of the coatings was calculated to be 22.7 g/g based on the weight of the coatings when swollen in DI H₂O, according to Equation (b). Finally, the dried coated papers were then immersed in 0.9% aqueous NaCl to determine the capacity of the coating in this medium, which was calculated to be 23.8 g/g.

For comparison, the uncoated filter paper had a capacity in deionized water of 2.06±0.03. In the absence of any base treatment, the gel coating had a deionized water capacity of 1.52±0.03.

### Example 33

A polymer was synthesized according to the method of Example 18 except that the neutralization was carried out using about 30 g of particles. Samples of the particles were subjected to the Solubles test, the Zero Load Capacity test for deionized water, 0.9 wt % NaCl, and SURINE®, and the Capacity Under Load test for 0.9 wt % NaCl. The polymer was found to have 32.3% solubles, zero load capacity of 81.7 g DI H₂O/g, 29.4 g 0.9 wt % NaCl/g, and 27.3 g SURINE®/g, and 25.0 g 0.9 wt % NaCl/g under 0.909 lb/in² load.

Twelve 50 mL centrifuge tubes were each charged with approximately 0.2 g of the polymer synthesized according to the method of Example 18, 45 mL of deionized water, and 200 μL of SURINE®. The pH of the twelve tubes was measure and was found to range between 9.1 and 9.5. The tubes were labeled “CONTROL”. Another twelve 50 mL centrifuge tubes were prepared in the same manner as the CONTROL tubes except that in addition to the other components, 300 μL of a 100 mg/mL solution of citric acid monohydrate was added to each tube. These tubes were labeled “CITRIC ACID”. The pH of the CITRIC ACID set ranged from 3.0-4.0; mean pH was 3.8. All of the tubes were placed on a shaker at 80 rpm at laboratory temperature for about 20 hours, at which point the pH of the CONTROL set ranged from 9.5-10.0 and the pH of the CITRIC ACID set ranged from 3.5-4.0. An additional 600 μL of a 50 mg/mL solution of citric acid monohydrate, was added to each of the CITRIC ACID tubes, then all the tubes were placed back on the shaker set to 80 rpm at ambient temperature. The pH of the CITRIC ACID set after the introduction of additional citric acid solution was ranged from 3.0-4.0.

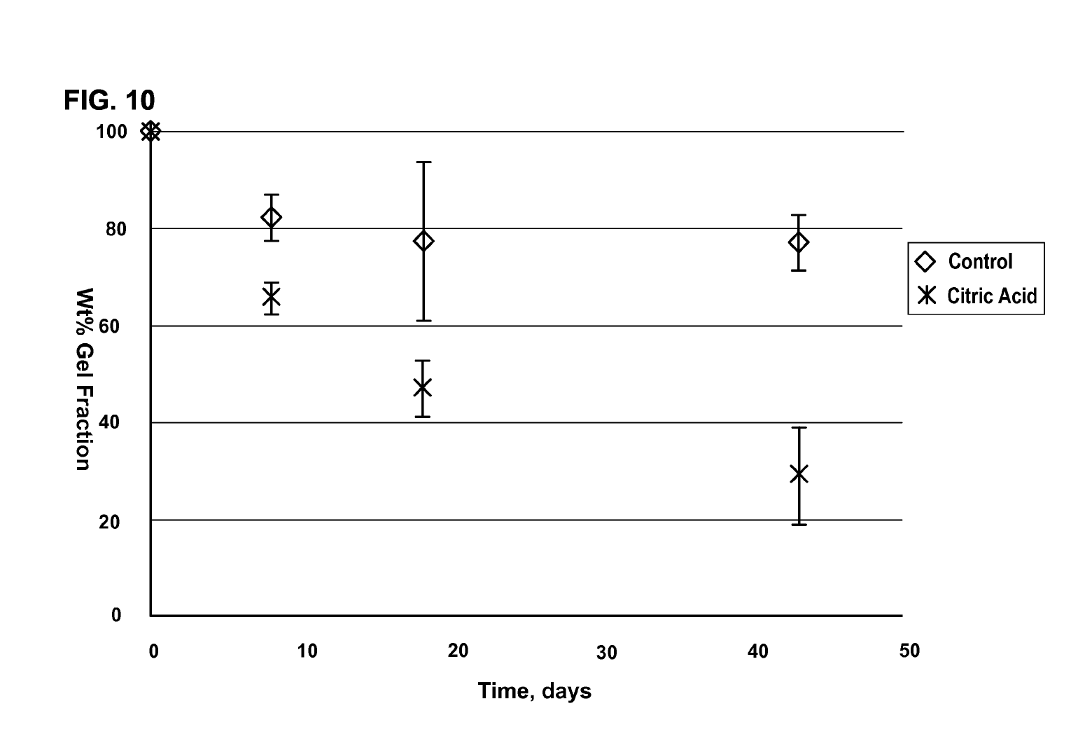

At periodic intervals over the subsequent 43 days, three of the tubes from each of the two sets of tubes were removed from the shaker, the pH was measured, then the contents of each tube was gravity filtered through a fresh tared FISHERBRAND® Filter Paper Qualitative P2, Fine Porosity, Slow Flow Rate (obtained from Fisher Scientific of Waltham, Mass.). The filter paper is reported to have particle retention capacity of 1-5 μm and a Hertzberg flow rate of 1400 seconds. After emptying the contents of each tube onto the filter paper, the tube was rinsed with about 10 mL deionized water and the rinsate was used to wash the material on the filter paper. The material remaining on the filter paper is considered the gel fraction of the material. The gel fraction and the fraction that passed through the filter paper were dried to a constant weight in a drying oven set to 105° C. The ratio of the mean dry mass of gel and mean dry mass of the fractions that passed through the filter paper were normalized to reflect 100% total, and the results are shown in the plot of FIG. 10. Referring to FIG. 10, each data point represents the mean of triplicate samples, with upper and lower error bars each representing 26 (two standard deviations).

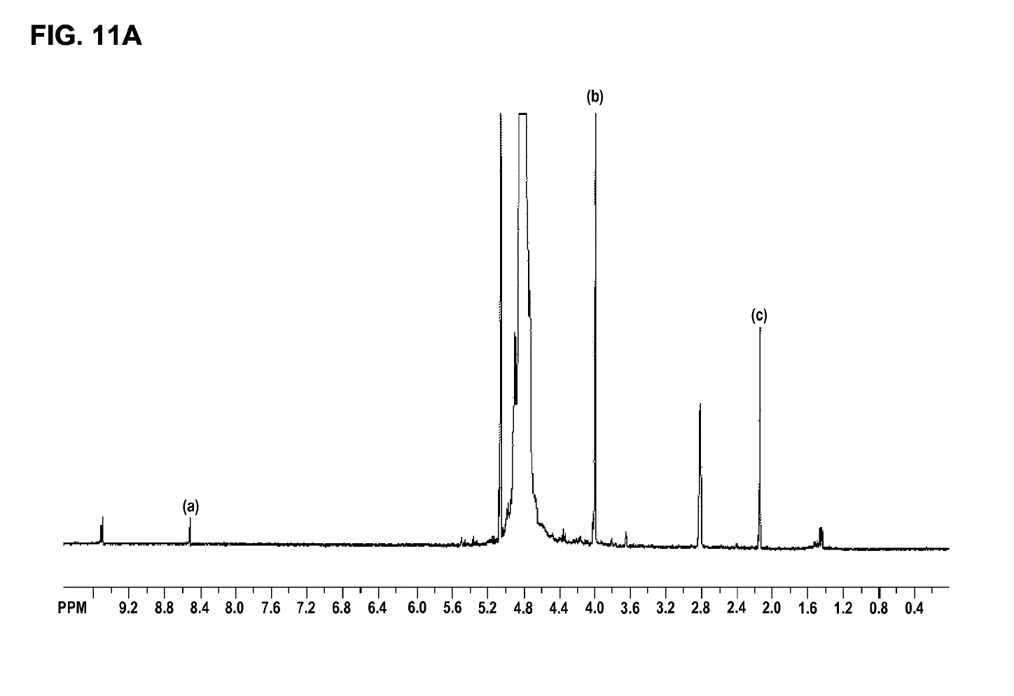

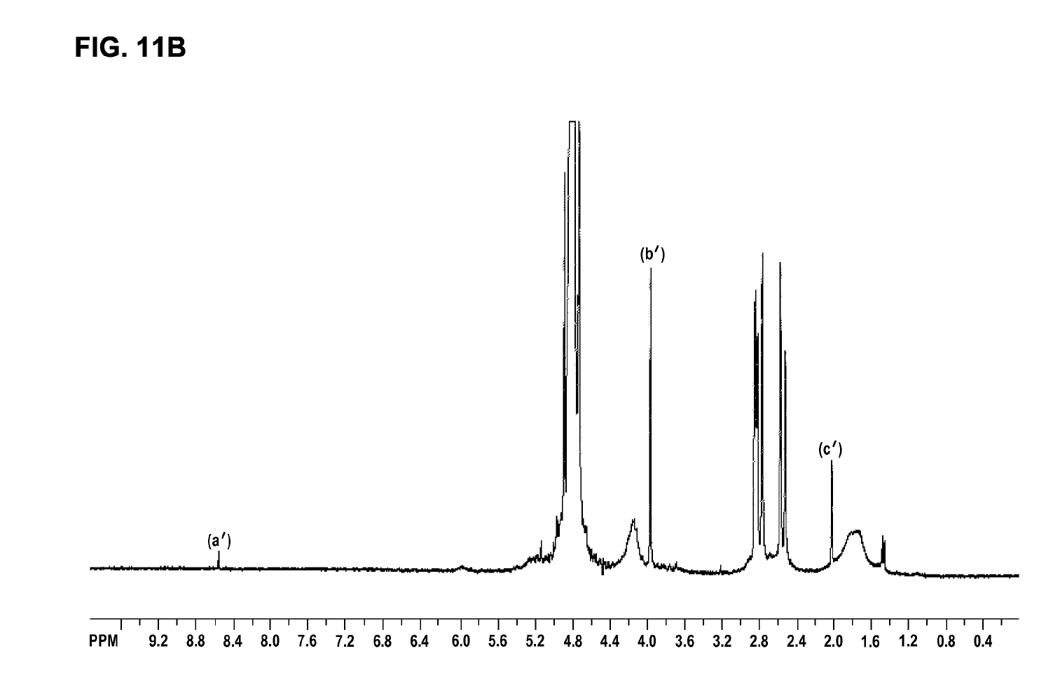

After 93 days, the CITRIC ACID sample was observed to be homogeneous in appearance, with no apparent hydrogel remaining. ¹H NMR was used to further characterize the nature of the degelled composition. First, sodium glyoxylate was prepared by weighing 4.8 g of a 50 wt % glyoxylic acid solution (used as supplied) into a 20 mL glass scintillation vial. Then 1.34 g of sodium hydroxide (obtained from Fisher Scientific of Waltham, Mass.) dissolved in about 15 mL of deionized water was added portionwise to the glyoxylic acid solution over two minutes. The mixture became warm during the addition. After the addition was complete, the mixture was allowed to cool to laboratory temperature. Then 1 mL of the mixture was added to a petri dish and water was evaporated in the drying oven at 105° C. The residual solid was dissolved in at 1:1 mixture of D₂O:d₆-DMSO, and ¹H NMR analysis carried out. The result is shown in FIG. 11A.

A 20 mL aliquot of the CITRIC ACID sample was collected in a 50 mL plastic centrifuge tube at 93 days after mixing. This sample was colorless, transparent, and homogeneous in appearance. The top of the tube was sealed tightly with a cellulose dialysis membrane (lower MW cutoff=10,000, conditioned by boiling 3× in DI water prior to use) using rubber bands. The tube was then inverted, and a hole was cut in the top of the tube to equalize pressure inside the tube with atmospheric pressure. The tube was held in place with a ring stand support and immersed in 150 mL of deionized water that was stirred with a magnetic stir bar for 16 hours at laboratory temperature. The contents of the beaker after this time (that is, the dialyzate) were transferred to a 1000 mL round bottom flask and pH was adjusted to approximately 7 by addition of sodium bicarbonate (obtained from Fisher Scientific of Waltham, Mass.). The flask was placed on a rotary evaporator and the dialyzate was evaporated while immersed in an oil bath set to 55° C. The resulting white solid was taken up in 1:1 D₂O:d₆-DMSO and analyzed by ¹H NMR; the spectrum is shown in FIG. 11B.

Referring to FIG. 11B, a proton resonance observed at approximately 8.59 ppm, labelled (a′), is attributable to an aldehyde moiety; resonance (a′) is comparable with the aldehydic proton resonance (a) observed at 8.54 ppm in FIG. 11A. Other resonances common to the sodium glyoxylate standard of FIG. 11A are also observed in FIG. 11B at approximately 3.9 ppm ((b) and (b′), respectively), 2.1 ppm ((c) and (c′), respectively), and 1.4 ppm ((d) and (d′), respectively. Signals in the range of 2.9 to 2.4 ppm in FIG. 11B are ascribed to sodium citrate/citric acid, which overlaps with resonances attributable to DMSO. By comparison, the ¹H NMR of the PVGA of Example 28 (FIG. 8) shows that after synthesis of a PVGA, no aldehydic proton absorptions are observed. The commonality of specific proton resonances described in FIGS. 11A and 11B support the hypothesis that degelling of PVGA proceeds through hydrolysis of acetals and release of glyoxylate.

### Examples 34-44

The particles obtained in Example 21 were subjected to a series of washes using mixtures of water and a water miscible solvent (aqueous solvent solution). Into a series of 50 mL polypropylene centrifuge tubes were weighed approximately 0.2 g per tube of the particles obtained in Example 21. Aqueous solvent solutions were formed by admixing water with a selected volume % of a water miscible solvent. Acetone, methanol, ethanol, and isopropanol were employed as the water miscible solvents. Then 25 mL of a 1^{st} aqueous solvent solution, as indicated in Table 8, was added to a tube. The particles were allowed to absorb the 1^{st} aqueous solvent solution at laboratory temperature until a constant particle volume was reached. The volume occupied by the particles was recorded by matching the height of the particles in the centrifuge tube with the graduation marks on the side of the tube. Unabsorbed residual liquid present in the tube was then decanted and the procedure was repeated with 2^{nd} and optionally 3^{rd} aqueous solvent solutions as indicated in Table 8.

TABLE 8
Water-solvent compositions used for each of two or three
washes of the particles from Example 21.

| | | Vol % of |
|---|---|---|
| Example | Aqueous Solvent | Solvent in 1^{st}, |
| No. | Solution | 2^{nd}, 3^{rd} wash |
| 34 | Water (CONTROL) | 0, 0, 0 |
| 35 | Water - Acetone | 40, 60, 80 |
| 36 | Water - Acetone | 60, 60, 60 |
| 37 | Water - MeOH | 40, 60, 80 |
| 38 | Water - MeOH | 80, 80, 80 |
| 39 | Water - EtOH | 30, 60, 80 |
| 40 | Water - EtOH | 80, 80, 80 |
| 41 | Water - iPrOH | 80, 80, 80 |
| 42 | Water - iPrOH | 20, 60, 80 |
| 43 | Water - iPrOH | 65, 60, 100 |
| 44 | Water - iPrOH | 70, 100 |

The percent solids present in the swollen particles was determined according to the following formula and the results are reported in Table 9:

% solids=[(dry mass of particles)/(volume of swollen particles)*100]

The final volume of the swollen PVGA hydrogel particles was determined using the procedure described in U.S. Pat. No. 4,350,773:

Final PVGA Volume=(volume of swollen particles,mL)/(theoretical dry mass of particles,g)

The results are reported in Table 9. Then the particles were dried in a drying oven at 105°-110° C. for three hours. The dried particles were subjected to the Solubles test and the Zero Load Capacity test for 0.9 wt % NaCl. The results are reported in Table 9.

TABLE 9
Final PVGA hydrogel volume after all washes, % solids, % solubles,
and capacity of the aqueous solvent solution washed particles from
Examples 34-44.

| | | | | Capacity, g |
|---|---|---|---|---|
| Example | Final PVGA | | | 0.9 wt % |
| No. | Volume (mL/g) | % Solids | % Solubles | NaCl/g |
| 34 | 362 | 0.30 | 49.6 | 47.3 |
| 35 | 35.9 | 2.8 | 38.9 | 48.0 |
| 36 | 85.2 | 1.2 | 27.0 | 38.3 |
| 37 | 272 | 0.4 | 36.9 | 40.1 |
| 38 | 217 | 0.5 | 28.9 | 32.8 |
| 39 | 203 | 0.5 | 36.4 | 39.0 |
| 40 | 13.7 | 7.3 | 8.7 | 29.6 |
| 41 | 14.0 | 7.1 | 10.9 | 29.9 |
| 42 | 95.4 | 1.0 | 36.2 | 42.1 |
| 43 | 8.6 | 11.6 | 5.8 | 32.4 |
| 44 | 8.2 | 12.1 | 0.7 | 29.2 |

### Examples 45-58

The PVGA polymer synthesized in Example 28 was employed as the 3.9 wt % solids concentrate. The following Metal Catalyst solutions were prepared:
Co²⁺: Cobalt(II) chloride 97%, 6.2 mg dissolved in 6.2 mL DI water
Cu²⁺: Copper(II) chloride 97%, 6.9 mg dissolved in 6.9 mL DI water
Mn²⁺: Manganese(II) chloride 98%, 5.9 mg dissolved in 5.9 mL DI water
Mn³⁺: Manganese(III) acetate dehydrate, 5.4 mg suspended in 5.4 mL DI water
Fe²⁺: Iron(II) sulfate heptahydrate 99.5% (obtained from Acros Organics of Geel, Belgium), 13.2 mg dissolved in 5.4 mL DI water
   The following Oxidant solutions were prepared:
K₂S₂O₈: Potassium persulfate, 19.2 mg dissolved in 2 mL DI water
NaIO₄: Sodium (meta)periodate, 10.3 mg dissolved in 1 mL DI water
H₂O₂: 30% solution in water, used as received.

Examples 45-58 were prepared by admixing 1.0 g of 3.9 wt % PVGA of Example 28 with the components reported in Table 10 in 15 mL plastic centrifuge tubes. The tubes were then capped, without degassing or excluding air from the tubes, and placed on a laboratory shaker at ambient temperature for 3 days. Then the contents of the tube were analyzed to determine number average molecular weight (Mn) and polydispersity (PDI) by GPC using the procedure outlined above. The results are reported in Table 10.

The PVOH starting material for the synthesis of the PVGA of Example 28 was analyzed by GPC, and the M. and PDI were 3,400 and 4.3, respectively. The PVGA of Example 28 was analyzed by GPC, and the M. and PDI were 15,800 and 14.7, respectively. Control Example 45C is the PVGA of Example 28 subjected to shaking for 3 days in the presence of water and air entrained in the closed centrifuge tube, prior to GPC analysis.

TABLE 10
Components and amounts added to PVGA mixtures, and GPC
analysis results for the mixtures after 3 days.

| Example | Oxidant | Metal Catalyst | | |
|---|---|---|---|---|
| No. | solution, μL | solution, μL | Mₙ | PDI |
| 45C | None | None | 11,800 | 15.3 |
| 46 | H₂O₂, 15 | None | 4,300 | 4.9 |
| 47 | K₂S₂O₈, 460 | None | 13,100 | 5.4 |
| 48 | NaIO₄, 430 | None | 3,300 | 5.4 |
| 49 | None | Co²⁺, 400 | 12,900 | 22.6 |
| 50 | None | Cu²⁺, 400 | 13,000 | 23.3 |
| 51 | None | Mn²⁺, 400 | 12,800 | 24.6 |
| 52 | None | Mn³⁺, 400 | 13,700 | 20.5 |
| 53 | None | Fe²⁺, 400 | 10,500 | 27.3 |
| 54 | H₂O₂, 15 | Co²⁺, 400 | 4,200 | 4.7 |
| 55 | H₂O₂, 15 | Cu²⁺, 400 | 5,000 | 4.4 |
| 56 | H₂O₂, 15 | Mn²⁺, 400 | 3,100 | 3.9 |
| 57 | H₂O₂, 15 | Mn³⁺, 400 | 3,600 | 4.2 |
| 58 | H₂O₂, 15 | Fe²⁺, 400 | 1,200 | 7.3 |

As shown in Table 10, substantial reduction in molecular weight of PVGA is observed upon treatment with hydrogen peroxide as well as sodium periodate in the absence of any metal catalyst. Those samples in the presence of metal catalysts but without added oxidant solution did not show significant reduction in M. but did exhibit an increase in polydispersity. Samples in the presence of both metal catalyst and oxidant exhibited a reduction in molecular weight to a level close to that of the PVOH used in the synthesis of the PVGA of Example 28. Notably, molecular weight below the observed Mₙ for the PVOH starting polymer was observed in the presence of both hydrogen peroxide and Fe²⁺.

¹H NMR analysis was carried out on several of the Examples. The spectrum of the degraded polymer of both Example 46 and Example 58 indicate the presence of an aldehydic proton at 8.42 ppm. Proton NMR of a sodium glyoxylate standard in the same NMR solvent system (shown in FIG. 11A) shows the presence of this aldehydic proton resonance at 8.40 ppm. Comparison of these two proton NMR spectra confirm the presence of aldehyde function groups either on the chain end of oxidized PVGA or as glyoxylic species cleaved from the PVGA chain. In conclusion, the Fe²⁺/H₂O₂ catalytic system was most effective at degrading PVGA in this study. It can also be reasonably proposed that the treatment results in deacetalization and/or backbone scission due to the observed presence of aldehyde functional groups.

### Example 59

A polymer was prepared according to Example 14 except that the water washing step was omitted. The absorption capacity of the dried, unwashed polymer was determined to be 15 g of 0.9 wt % NaCl in water per gram.

### Example 60

A polymer was prepared according to Example 25, except that the sized particles (850 μm-1.4 mm) were not subjected the Neutralization Procedure. Into each of four 20 mL scintillation vials was placed about 0.2 g of particles. Then 10% aqueous sodium hydroxide solution was added by micropipette to each vial in an amount corresponding to 105% molar equivalent of theoretical free carboxylic acid groups present in the polymer. Then the vials were capped and placed in an oven at 70° C. for the time indicated in Table 11.

After removing the vials from the oven, the samples were each transferred to 50 mL polypropylene centrifuge tubes and washed three times with 50 mL portions of deionized water. Excess water was removed using a syringe and the hydrogel was placed in a pre-weighed glass petri dish. Interstitial water was removed by contacting the material with a laboratory wipe. The material was then weighed on an analytical balance to determine hydrogel mass (capacity of the hydrogel). The capacity of the samples are reported in Table 11.

TABLE 11
Capacity of PVGA as a function of time subjected to NaOH solution.

| Time at | Capacity, g |
|---|---|
| 70° C., hr | H₂O/g polymer |
| 1 | 75.6 |
| 2 | 81.6 |
| 4 | 88.2 |
| 16 | 95.0 |

1. A particle comprising a polymer composition, the polymer composition comprising a neutralized poly(vinyl glyoxylic acid), the particle comprising convoluted surface morphology features.

2. The particle of claim 1 wherein the neutralized poly(vinyl glyoxylic acid) comprises sodium, potassium, lithium, or ammonium carboxylate groups.

3. The particle of claim 1 wherein the convoluted surface features have heights of about 10 nm to 25 μm, and periodicity of about 10 nm to 50 μm.

4. The particle of claim 1 wherein the convoluted surface morphology features are present on about 10% to 100% of the particle surface.

5. The particle of claim 1 wherein the polymer composition is capable of forming a hydrogel with an aqueous liquid.

6. The particle of claim 1 wherein the particle is capable of absorbing 0.9 wt % NaCl solution at an initial rate of about 1 g to 25 g of solution per gram of polymer composition per minute at 20° C. to 27° C.

7. The particle of claim 1 wherein the particle comprises a particle size of between about 1 micrometer and 3 millimeters.

8. The particle of claim 1 wherein the particle comprises a particle size of between about 100 micrometers and 1 millimeter.

9. The particle of claim 1 wherein the particle comprises an absorption capacity of about 16 g to about 50 g of 0.9 wt % NaCl solution per gram of the polymer composition at about 20° C. to 27° C.

10. A formulation comprising the particle of claim 1 and one or more formulation components, the formulation components comprising solvents, aqueous liquids, aqueous solvent mixtures, celluloses, starches, lignins, polysaccharides, surfactants, clays, micas, drilling fluids, insecticides, herbicides, fertilizers, fragrances, drugs, fire-retardant agents, personal care formulation components, coating additives, cyclodextrins, fillers, adjuvants, thermal stabilizers, UV stabilizers, colorants, acidulants, metals, microorganisms, spores, encapsulated organic acids, mixtures thereof, and combinations of two or more thereof.

11. The formulation of claim 10 wherein the particle is admixed with the one or more formulation components.

12. The formulation of claim 10 wherein the one or more formulation components is entrained within the particle.

13. An article comprising the particle of claim 1, wherein the article is a diaper for an infant, an adult protective undergarment or incontinence undergarment, a feminine sanitary napkin, an underground power or communications cable, a horticultural water retention agent, control agent for aqueous fluid spill or effluent, a carrier for controlled release of insecticides, herbicides, fragrances, or drugs, a drilling fluid additive, a fire-retardant composition, a mortuary pad, a surgical pad, a wound dressing, a medical or other aqueous waste solidification article, an absorbent pad for food, a food packaging material, a cosmetic or personal care article, a sealing composite, a filter, a fuel monitor system for aviation and motor vehicles, a drown-free water source for caged insects, masking tape designed for use with latex paint, a hot/cold therapy pack, a motionless waterbed, a grow-in-water toy, or artificial snow for motion picture and stage production, or a combination of two or more thereof.

14. A coating comprising a polymer composition, the polymer composition comprising a neutralized poly(vinyl glyoxylic acid), the coating comprising convoluted surface morphology features.

15. The coating of claim 14 wherein the convoluted surface features have heights of between about 10 nm and 25 μm, and periodicity of between about 10 nm and 50 μm.

16. The coating of claim 14 wherein the polymer composition is capable of forming a hydrogel with an aqueous liquid.

17. The coating of claim 14 wherein the coating is capable of absorbing 0.9 wt % NaCl solution at an initial rate of about 1 to 25 g of solution per gram of polymer composition per minute at 20° C. to 27° C.

18. The coating of claim 14 wherein the coating comprises an absorption capacity of about 16 to 50 g of 0.9 wt % NaCl solution per gram of the polymer composition at 20° C. to 27° C.

19. The coating of claim 14 wherein the convoluted surface morphology features are present on about 10% to 100% of the coating surface.

20. The coating of claim 14 wherein the coating is continuous or discontinuous.

21. The coating of claim 14 wherein the coating is disposed on a substrate, the substrate comprising a particle, a fiber, a film, a sheet, a plate, a nonwoven fabric or sheet, a woven fabric, or a coated particle, fiber, film, sheet, plate, or fabric.

22. The coating of claim 14 further comprising one or more solvents, aqueous liquids, aqueous solvent mixtures, celluloses, starches, lignins, polysaccharides, surfactants, clays, micas, drilling fluids, insecticides, herbicides, fertilizers, fragrances, drugs, fire-retardant agents, personal care formulation components, coating additives, cyclodextrins, fillers, adjuvants, thermal stabilizers, UV stabilizers, colorants, acidulants, metals, microorganisms, spores, encapsulated organic acids, a mixture of two or more thereof, or a combination of two or more thereof.

23. An article comprising the coating of claim 14, the article comprising a diaper for an infant, an adult protective undergarment or incontinence undergarment, a feminine sanitary napkin, an underground power or communications cable, a horticultural water retention agent, control agent for aqueous fluid spill or effluent, a carrier for controlled release of insecticides, herbicides, fragrances, or drugs, a drilling fluid additive, a fire-retardant composition, a mortuary pad, a surgical pad, a wound dressing, a medical or other aqueous waste solidification article, an absorbent pad for food, a food packaging material, a cosmetic or personal care article, a sealing composite, a filter, a fuel monitor system for aviation and motor vehicles, a drown-free water source for caged insects, masking tape designed for use with latex paint, a hot/cold therapy pack, a motionless waterbed, a grow-in-water toy, or artificial snow for motion picture and stage production, or a combination of two or more thereof.

24. A method of making a polymer composition, the polymer composition comprising a neutralized poly(vinyl glyoxylic acid), the method comprising
a. combining about 5 wt % to 25 wt % polyvinyl alcohol in water with one or more glyoxylate derivatives to form a reaction mixture;
b. evaporating at least a portion of the water from the reaction mixture;
c. contacting the reaction mixture with a base to form the polymer composition;
d. washing the polymer composition with a water miscible solvent or a solvent mixture, the solvent mixture comprising a water miscible solvent; and
e. removing at least a portion of the water miscible solvent or the mixture.

25. The method of claim 24 wherein the water miscible solvent is methanol, ethanol, isopropanol or acetone.

26. The method of claim 24 wherein the solvent mixture further comprises water.

27. The method of claim 24 wherein the method further comprises coating the reaction mixture on a substrate.

28. The method of claim 24 wherein the method further comprises dividing the reaction mixture or the polymer composition.

29. The method of claim 24 wherein the method is a continuous method.

30. A method of degelling a hydrogel, the hydrogel comprising a neutralized poly(vinyl glyoxylic acid) and an aqueous liquid, the method comprising contacting the hydrogel with a weak organic acid in an amount sufficient to cause degelling of at least a portion of the contacted hydrogel.

31. The method of claim 30 wherein the weak organic acid is citric acid, succinic acid, malic acid, fumaric acid, lactic acid, or O-lactoyllactic acid.

32. The method of claim 30 wherein contacting the weak organic acid with the aqueous liquid causes the weak organic acid to contact the poly(vinyl glyoxylic acid).

33. The method of claim 30 wherein the weak organic acid is encapsulated prior to contacting with the aqueous liquid.

34. The method of claim 30 wherein the weak organic acid is a latent acidulant.

35. The method of claim 30 wherein 10 days after the contacting, at least about 30 wt %, of the contacted hydrogel capable of passing through a paper filter having particle retention capacity of 1-5 μm and a Hertzberg flow rate of 1400 seconds.

36. A particle comprising a polymer composition, the polymer composition comprising a neutralized poly(vinyl glyoxylic acid), the particle comprising convoluted surface morphology features, the particle made by the method comprising:
a. forming a hydrogel comprising the polymer composition and water;
b. washing the hydrogel with a water miscible solvent or a solvent mixture, the solvent mixture comprising a water miscible solvent; and
c. evaporating at least a portion of the water miscible solvent or the mixture.

37. The particle of claim 36, wherein the solvent mixture further comprises water.

38. A coating comprising a polymer composition, the polymer composition comprising a neutralized poly(vinyl glyoxylic acid), the coating comprising convoluted surface morphology features, the coating made by the method comprising:
a. coating a reaction mixture onto a substrate, the reaction mixture comprising a mixture of about 5 wt % to 25 wt % polyvinyl alcohol in water and one or more glyoxylate derivatives;
b. evaporating at least a portion of the water;
c. contacting the coated reaction mixture with a base to form a polymer composition;
d. washing the polymer composition with a water miscible solvent or a solvent mixture, the solvent mixture comprising a water miscible solvent; and
e. evaporating at least a portion of the water miscible solvent or the mixture.

39. The particle of claim 38, wherein the solvent mixture further comprises water.

40. A polymer composition comprising the reaction product of a glyoxylate derivative and a polyvinyl alcohol, wherein the polymer composition is capable of forming a hydrogel with an aqueous liquid, the dry polymer composition having an absorption capacity of about 16 to 50 g of 0.9 wt % NaCl solution per gram of the dry polymer composition and is capable of an initial rate of absorption of about 1 to 25 g of 0.9 wt % NaCl solution per gram of dry polymer composition per minute.

41. The polymer composition of claim 40 wherein the polyvinyl alcohol comprises an alcoholyzed polyvinyl acetate having a molecular weight of between about 10,000 g/mol and 3,000,000 g/mol, wherein about 80% to 100% of the acetate groups are alcoholyzed to hydroxyl groups.

42. The polymer composition of claim 41 wherein the polyvinyl alcohol has a molecular weight of between about 10,000 g/mol and 250,000 g/mol.

43. The polymer composition of claim 41 wherein about 95% to 99% of the acetate groups are alcoholyzed to hydroxyl groups.

44. The polymer composition of claim 40 wherein between about 30% and 90% of the hydroxyl groups of the polyvinyl alcohol are reacted with the glyoxylate derivative.

45. The polymer composition of claim 40 wherein between about 50% and 75% of the hydroxyl groups of the polyvinyl alcohol are reacted with the glyoxylate derivative.

46. The polymer composition of claim 40 wherein the glyoxylate derivative comprises sodium glyoxylate, potassium glyoxylate, glyoxylic acid, or a combination of two or more thereof.

47. The polymer composition of claim 40 wherein the reaction product further comprises crosslinks attributable to a dialdehyde.

48. The polymer composition of claim 47 wherein the dialdehyde is glyoxal or glutaraldehyde.

49. The polymer composition of claim 40 wherein the polymer composition comprises a coating, a sheet, or a fiber.

50. The polymer composition of claim 40 wherein the polymer composition comprises a particle comprising a particle size of between about 50 nanometers and 3 millimeters and a water content of less than about 5 wt %.

51. The polymer composition of claim 50 wherein the particle comprises a particle size of between about 100 micrometers and 1 millimeter.

52. The polymer composition of claim 40 wherein the polymer composition comprises convoluted surface morphology features.

53. A formulation comprising the polymer composition of claim 40 and one or more formulation components, the formulation components comprising solvents, aqueous liquids, surfactants, aqueous solvent mixtures, celluloses, starches, lignins, polysaccharides, clays, micas, drilling fluids, insecticides, herbicides, fertilizers, fragrances, drugs, fire-retardant agents, personal care formulation components, coating additives, cyclodextrins, fillers, adjuvants, thermal stabilizers, UV stabilizers, colorants, acidulants, metals, microorganisms, spores, encapsulated organic acids, mixtures thereof, and combinations of two or more thereof.

54. An article comprising the polymer composition of claim 40, wherein the article is a diaper for an infant, an adult protective undergarment or incontinence undergarment, a feminine sanitary napkin, an underground power or communications cable, a horticultural water retention agent, control agent for aqueous fluid spill or effluent, a carrier for controlled release of insecticides, herbicides, fragrances, or drugs, a drilling fluid additive, a fire-retardant gel, a mortuary pad, a surgical pad, a wound dressing, a medical waste solidification article, an absorbent pad for food, a food packaging material, a cosmetic or personal care article, a sealing composite, a filter, a fuel monitor system for aviation and motor vehicles, a drown-free water source for caged insects, masking tape designed for use with latex paint, a hot/cold therapy pack, a motionless waterbed; a grow-in-water toy, or artificial snow for motion picture and stage production, or a combination of two or more thereof.

55. A polymer composition comprising a neutralized poly(vinyl glyoxylic acid), the polymer composition made by the method comprising
a. combining about 5 wt % to 25 wt % polyvinyl alcohol in water with a mixture of glyoxylic acid and a glyoxylate salt to form a reaction mixture;
b. evaporating at least a portion of the water from the reaction mixture; and
c. contacting the reaction mixture with a base.

56. An article comprising the formulation of claim 10, wherein the article is a diaper for an infant, an adult protective undergarment or incontinence undergarment, a feminine sanitary napkin, an underground power or communications cable, a horticultural water retention agent, control agent for aqueous fluid spill or effluent, a carrier for controlled release of insecticides, herbicides, fragrances, or drugs, a drilling fluid additive, a fire-retardant composition, a mortuary pad, a surgical pad, a wound dressing, a medical or other aqueous waste solidification article, an absorbent pad for food, a food packaging material, a cosmetic or personal care article, a sealing composite, a filter, a fuel monitor system for aviation and motor vehicles, a drown-free water source for caged insects, masking tape designed for use with latex paint, a hot/cold therapy pack, a motionless waterbed, a grow-in-water toy, or artificial snow for motion picture and stage production, or a combination of two or more thereof.

57. An article comprising the formulation of 53, wherein the article is a diaper for an infant, an adult protective undergarment or incontinence undergarment, a feminine sanitary napkin, an underground power or communications cable, a horticultural water retention agent, control agent for aqueous fluid spill or effluent, a carrier for controlled release of insecticides, herbicides, fragrances, or drugs, a drilling fluid additive, a fire-retardant gel, a mortuary pad, a surgical pad, a wound dressing, a medical waste solidification article, an absorbent pad for food, a food packaging material, a cosmetic or personal care article, a sealing composite, a filter, a fuel monitor system for aviation and motor vehicles, a drown-free water source for caged insects, masking tape designed for use with latex paint, a hot/cold therapy pack, a motionless waterbed; a grow-in-water toy, or artificial snow for motion picture and stage production, or a combination of two or more thereof.
